(19) United States
(12) Patent Application Publication
(10) Pub. No.: US 2024/0284201 A1
(43) Pub. Date: Aug. 22, 2024

(54) ML MODEL CATEGORY GROUPING CONFIGURATION

(71) Applicant: QUALCOMM Incorporated, San Diego, CA (US)

(72) Inventors: Yuwei REN, Beijing (CN); Huilin XU, Temecula, CA (US); June NAMGOONG, San Diego, CA (US)

(21) Appl. No.: 18/570,601

(22) PCT Filed: Aug. 10, 2021
(86) PCT No.: PCT/CN2021/111676

§ 371 Date: Dec. 14, 2023

(51) Int. Cl. H04W 24/02; G06N 20/00

(52) U.S. Cl. CPC H04W 24/02; G06N 20/00

(57) ABSTRACT

This disclosure provides systems, devices, apparatus, and methods, including computer programs encoded on storage media, for ML model grouping techniques. A UE may receive a configuration for one or more ML models, which may be based on a capability of the UE. The configuration may be associated with at least one of a task or a condition of at least one procedure of the UE. The one or more ML models may be switchable at the UE based on the condition of the at least one procedure of the UE. The UE may allocate the one or more ML models to at least one of a BMG or an SMG for switching between the one or more ML models based on the at least one of the task or the condition of the at least one procedure of the UE.

### INTRODUCTION

The present disclosure relates generally to communication systems, and more particularly, to machine learning (ML) model grouping techniques.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communication (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method includes receiving a configuration for one or more machine learning (ML) models, the configuration associated with at least one of a task or a condition of at least one procedure of the UE; and allocating the one or more ML models to at least one of a baseline model group (BMG) or a specific model group (SMG) for switching between the one or more ML models based on the at least one of the task or the condition of the at least one procedure of the UE.

In another aspect of the disclosure, an apparatus for wireless communication at a UE is provided. The apparatus includes means for receiving a configuration for one or more ML models, the configuration associated with at least one of a task or a condition of at least one procedure of the UE; and means for allocating the one or more ML models to at least one of a BMG or an SMG for switching between the one or more ML models based on the at least one of the task or the condition of the at least one procedure of the UE.

In another aspect of the disclosure, an apparatus for wireless communication at a UE is provided. The apparatus includes a memory and at least one processor coupled to the memory, the memory and the at least one processor configured to receive a configuration for one or more ML models, the configuration associated with at least one of a task or a condition of at least one procedure of the UE; and allocate the one or more ML models to at least one of a BMG or an SMG for switching between the one or more ML models based on the at least one of the task or the condition of the at least one procedure of the UE.

In another aspect of the disclosure, a non-transitory computer-readable storage medium at a UE, is provided. The non-transitory computer-readable storage medium is configured to receive a configuration for one or more ML models, the configuration associated with at least one of a task or a condition of at least one procedure of the UE; and allocate the one or more ML models to at least one of a BMG or an SMG for switching between the one or more ML models based on the at least one of the task or the condition of the at least one procedure of the UE.

In another aspect of the disclosure, a method of wireless communication at a base station is provided. The method includes receiving an indication of a UE capability for executing one or more ML models allocated to at least one of a BMG or an SMG; and transmitting a configuration for the one or more ML models, the configuration associated with at least one of a task or a condition of at least one procedure, the configuration for switching between the one or more ML models based on the at least one of the task or the condition of the at least one procedure.

In another aspect of the disclosure, an apparatus for wireless communication at a base station is provided. The apparatus includes means for receiving an indication of a UE capability for executing one or more ML models allocated to at least one of a BMG or an SMG; and means for transmitting a configuration for the one or more ML models, the configuration associated with at least one of a task or a condition of at least one procedure, the configuration for switching between the one or more ML models based on the at least one of the task or the condition of the at least one procedure.

In another aspect of the disclosure, an apparatus for wireless communication at a base station is provided. The apparatus includes a memory and at least one processor coupled to the memory, the memory and the at least one processor configured to receive an indication of a UE capability for execution of one or more ML models allocated to at least one of a BMG or an SMG; and transmit a configuration for the one or more ML models, the configuration associated with at least one of a task or a condition of at least one procedure, the configuration for switching between the one or more ML models based on the at least one of the task or the condition of the at least one procedure.

In another aspect of the disclosure, a non-transitory computer-readable storage medium at a base station, is provided. The non-transitory computer-readable storage medium is configured to receive an indication of a UE capability for execution of one or more ML models allocated to at least one of a BMG or an SMG; and transmit a configuration for the one or more ML models, the configuration associated with at least one of a task or a condition of at least one procedure, the configuration for switching between the one or more ML models based on the at least one of the task or the condition of the at least one procedure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates a diagram of a UE that includes a neural network configured for determining communications with a second device.

FIG. 5 illustrates an example diagram including different types of machine learning (ML) model structures.

FIG. 6A is a diagram illustrating an allocation for ML models of a baseline model group (BMG).

FIG. 6B is a diagram illustrating an allocation for ML models of a specific/dedicated model group (SMG).

FIG. 7A is a diagram illustrating a sub-allocation for ML models in the BMG into ML model subgroups.

FIG. 7B is a diagram illustrating a sub-allocation for ML models in the SMG into ML model subgroups.

FIG. 8A is a diagram illustrating a joint ML model configuration format and separate ML model configuration formats for the BMG.

FIG. 8B is a diagram illustrating a joint ML model configuration format and separate ML model configuration formats for the SMG.

FIGS. 9A-9B are diagram illustrating an association between a baseline model of the BMG and one or more specific/dedicated models of the SMG.

FIG. 10 is a call flow diagram illustrating communications between a UE and a network.

FIG. 11 is a call flow diagram illustrating communications between a UE and a base station.

FIG. 12 is a flowchart of a method of wireless communication at a UE.

FIG. 13 is a flowchart of a method of wireless communication at a UE.

FIG. 14 is a flowchart of a method of wireless communication at a base station.

FIG. 15 is a flowchart of a method of wireless communication at a base station.

FIG. 16 is a diagram illustrating an example of a hardware implementation for an example apparatus.

FIG. 17 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described techniques. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components (e.g., associated with a user equipment (UE) and/or a base station), end-user devices, etc. of varying sizes, shapes, and constitution.

Machine learning (ML) techniques may be based on one or more computer algorithms that are trained to automatically provide improved outputs for a processing operation based on stored training data and/or one or more prior executions. An ML model refers to an algorithm that is trained to recognize certain types of patterns, e.g., associated with the stored training data and/or the one or more prior executions, to learn/predict the improved outputs for the processing operation. ML models that are trained at a first device may be configured to a second device. For example, a network may transmit an ML model configuration to a UE to configure the UE with the ML model that was trained at the network, such that the UE may execute the ML model after receiving the ML model configuration from the network.

ML techniques may be used in wireless communication. Aspects presented herein include a plurality of ML models that may be configured to a UE for an ML inference procedure. “ML inference” refers to inputting real-time data into an ML model to provide an output for the real-time data that may be acted upon by a device associated with the ML model. “Procedure” refers to any action, function, operation, etc., performed by a device, such as a UE or a base station. Thus, an “ML inference procedure” refers to an action, function, operation, etc., performed by a device in association with an ML inference. The ML models may correspond to different application functions, UE capabilities, tasks/conditions, etc., of the UE. For example, a condition of the UE may correspond to a UE positioning procedure and a task of the UE may correspond to indoor positioning or outdoor positioning. Different ML models may have different performance levels and different complexities, such that some of the different ML models may be executed by the UE for a same task/condition. For example, if a plurality of ML models are configured to the UE for a positioning task, the UE may select one of the plurality of ML models to perform the positioning task.

The selected ML model may be a general model, which may also be referred to as a “baseline” model, that may be more robust and executed for more tasks/conditions than a specific/dedicated model, which may be dedicate to a single task. That is, specific models, which may also be referred to as a “dedicated” model, may be specific to a particular task of the UE. For instance, the baseline model may be executed for both indoor positioning tasks and outdoor positioning tasks, whereas a first specific/dedicated model may be executed for indoor positioning tasks and a second specific/dedicated model may be executed for outdoor positioning tasks. While the specific/dedicated models may provide an increased performance level for a particular task, an overall complexity of the specific/dedicated models may be higher than an overall complexity of the baseline models.

Configuring the plurality of ML models for a task/condition may be associated with increased signaling overhead for ML inference procedures. For example, if a specific/dedicated model is executed for an individual task, the UE may dynamically switch between the plurality of ML models to adapt to a different task. Accordingly, the ML models may be allocated into a first group (e.g., for specific/dedicated models) for a task of a condition, or allocated into a second group (e.g., for baseline models) for a condition, to reduce signaling overhead associated with ML model switching. For example, the plurality of ML models may be allocated into a baseline model group (BMG) including baseline models or a specific/dedicated model group (SMG) including specific/dedicated models based on one or more protocols.

Switching between ML model groups based on the different tasks/conditions of the UE may allow a performance of UE to be increased while maintaining model complexity. In some examples, the BMG and the SMG may be further allocated into subgroups to further increase performance at the UE. The one or more protocols for allocating the ML models into the BMG or the SMG may correspond to a generalized performance level of the ML models, an ML model complexity, a default/initial setting of the UE, whether the ML models are cell-specific or UE-specific, and/or a priority level of the ML models. Baseline models of the BMG may also be associated with specific/dedicated models of the SMG based on a joint configuration format for the BMG and the SMG, or separate configuration formats for the BMG and the SMG.

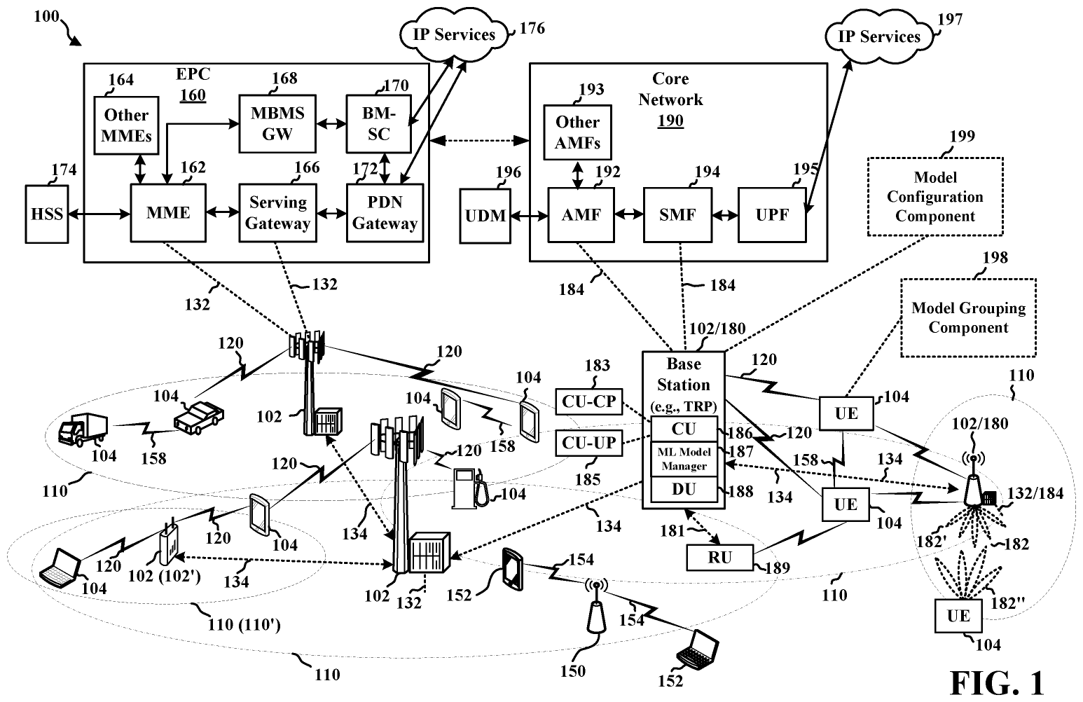

FIG. 1 is a diagram illustrating an example of a wireless communications system and an access network 100. Referring to FIG. 1, in certain aspects, a UE 104 may include a model grouping component 198 configured to receive a configuration for one or more ML models, the configuration associated with at least one of a task or a condition of at least one procedure of the UE; and allocate the one or more ML models to at least one of a BMG or a SMG for switching between the one or more ML models based on the at least one of the task or the condition of the at least one procedure of the UE. In certain aspects, a base station 180 may include a model configuration component 199 configured to receive an indication of a UE capability for execution of one or more ML models allocated to at least one of a BMG or an SMG; and transmit a configuration for the one or more ML models, the configuration associated with at least one of a task or a condition of at least one procedure, the configuration for switching between the one or more ML models based on the at least one of the task or the condition of the at least one procedure. Although the following description may be focused on 5G NR, the concepts described herein may be applicable to other similar areas, such as LTE, LTE-A, CDMA, GSM, and other wireless technologies.

The wireless communications system (also referred to as a wireless wide area network (WWAN)) in FIG. 1 is illustrated to include base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, which may be associated with the second backhaul link 184 from the base station 102, other AMFs 193, a Session Management Function (SMF) 194, which may also be associated with the second backhaul link 184 from the base station 102, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 may include a centralized unit (CU) 186 for higher layers of a protocol stack and/or a distributed unit (DU) 188 for lower layers of the protocol stack. The CU 186 may be associated with a CU-control plane (CU-CP) 183 and a CU-user plane (CU-UP) 185. The CU-CP 183 may be a logical node that hosts a radio resource control (RRC) and a control portion of a packet data convergence protocol (PDCP). The CU-UP 185 may be a logical node that hosts a user plane portion of the PDCP. The base station 102 may also include an ML model manager 187 that may authorize the UE 104 to download one or more ML models from the network. In further aspects, the base station 102 may communicate with a radio unit (RU) 189 over a fronthaul link 181. For example, the RU 189 may relay communications from the DU 188 to the UE 104.

The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

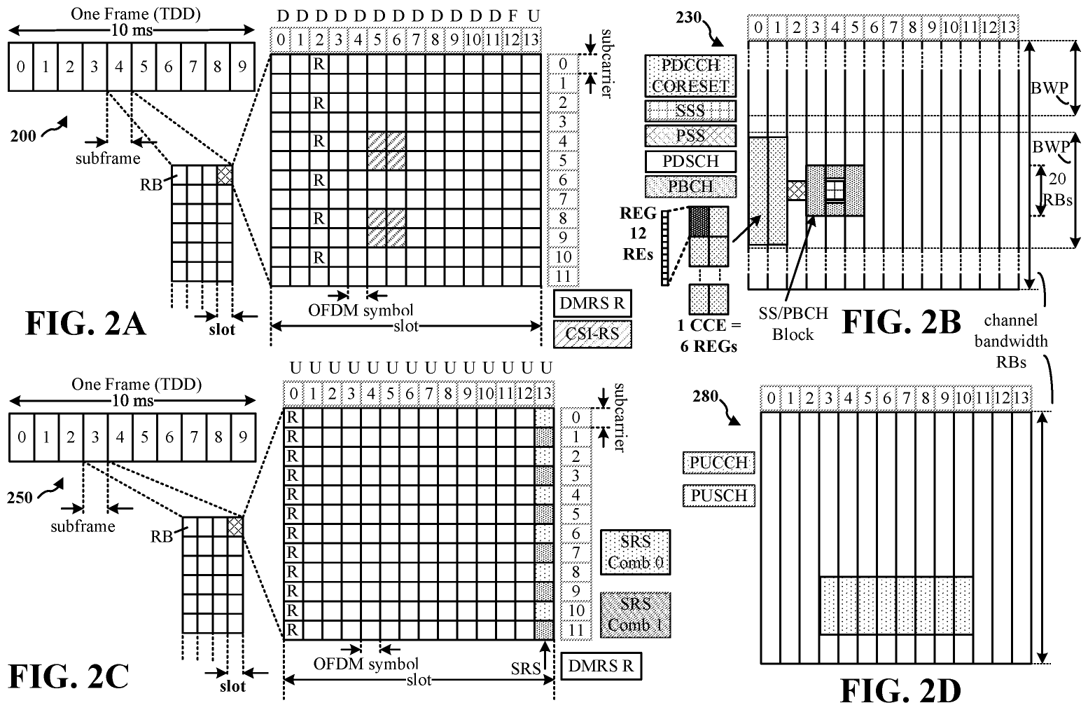

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through RRC signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

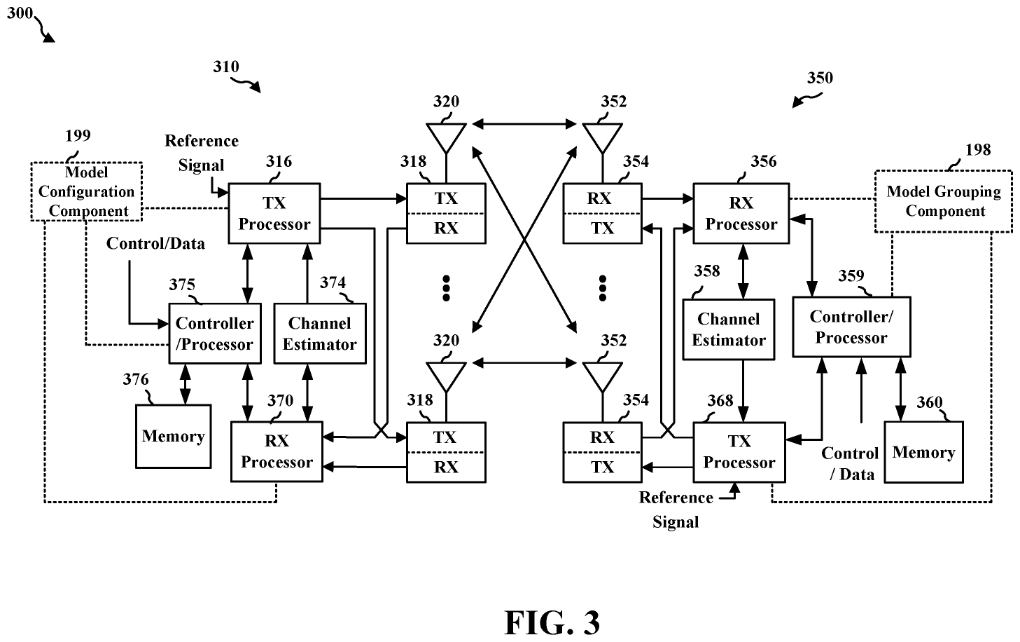

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a PDCP layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the model grouping component 198 of FIG. 1.

At least one of the TX processor 316, the RX processor 370, and the controller/processor 375 may be configured to perform aspects in connection with the model configuration component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

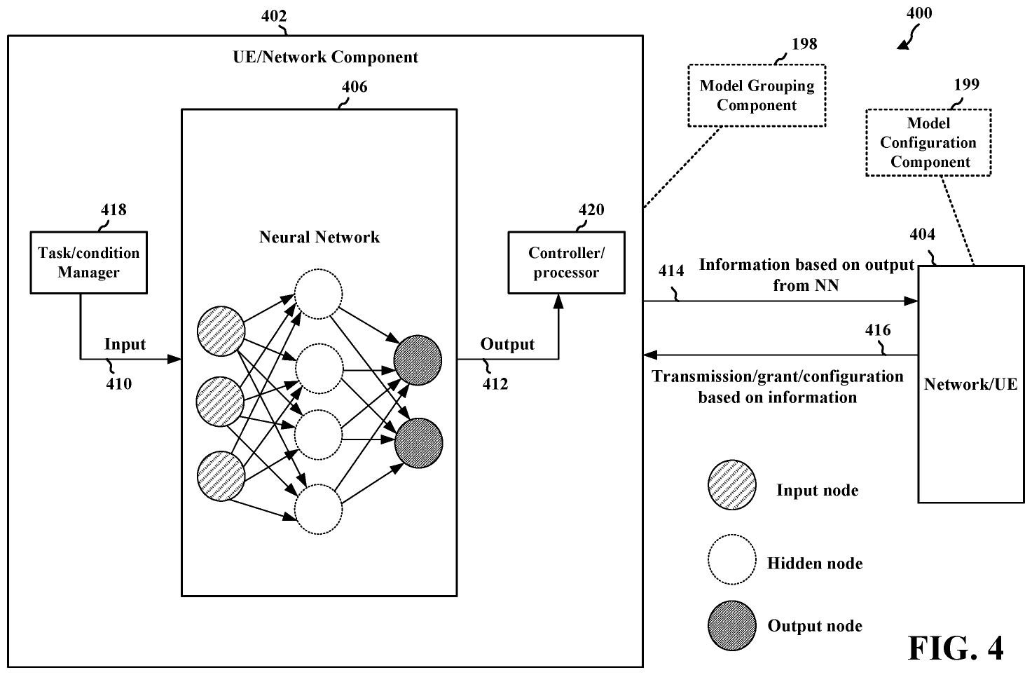

FIG. 4 illustrates a diagram 400 of a first wireless communication device 402 that includes a neural network 406 configured for determining communications with a second device 404. In some aspects, the neural network 406 may be included in a UE. The first wireless communication device 402 may be a UE, and the second device 404 may correspond to a second UE, a base station, or other network component, such as a core network component. In some aspects, the neural network 406 may be included in a network component. The first wireless communication device 402 may be one network component, and the second device 404 may be a second network component. A UE and/or a base station (e.g., including a (CU) and/or a distributed unit (DU)) may use machine-learning algorithms, deep-learning algorithms, neural networks, reinforcement learning, regression, boosting, or advanced signal processing methods for aspects of wireless communication, e.g., with a base station, a TRP, another UE, etc. The CU may provide higher layers of a protocol stack, such the SDAP, PDCP, RRC, etc., while the DU may provide lower layers of the protocol stack, such as the RLC, MAC, PHY, etc. A single CU may control multiple DUs, and each DU may be associated with one or more cells.

Reinforcement learning is a type of machine learning that involves the concept of taking actions in an environment in order to maximize a reward. Reinforcement learning is a machine learning paradigm; other paradigms include supervised learning and unsupervised learning. Basic reinforcement may be modeled as a Markov decision process (MDP) having a set of environment and agent states, and a set of actions of the agent. The process may include a probability of a state transition based on an action and a representation of a reward after the transition. The agent's action selection may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples. Federated learning (FL) procedures that use edge devices as clients may rely on the clients being trained based on supervised learning.

Regression analysis may include statistical processes for estimating the relationships between a dependent variable (e.g., which may be referred to as an outcome variable) and independent variable(s). Linear regression is one example of regression analysis. Non-linear models may also be used. Regression analysis may include inferring causal relationships between variables in a dataset.

Boosting includes one or more algorithms for reducing bias and/or variance in supervised learning, such as machine learning algorithms that convert weak learners (e.g., a classifier that is slightly correlated with a true classification) to strong ones (e.g., a classifier that is more closely correlated with the true classification). Boosting may include iterative learning based on weak classifiers with respect to a distribution that is added to a strong classifier. The weak learners may be weighted related to accuracy. The data weights may be readjusted through the process. In some aspects described herein, an encoding device (e.g., a UE, base station, or other network component) may train one or more neural networks to learn dependence of measured qualities on individual parameters.

The second device 404 may be a base station in some examples. The second device 404 may be a TRP in some examples. The second device 404 may be a network component, such as a DU, in some examples. The second device 404 may be another UE in some examples, e.g., if the communication between the first wireless device 402 and the second device 404 is based on sidelink. Although some example aspects of machine learning and a neural network are described for an example of a UE, the aspects may similarly be applied by a base station, an IAB node, or another training host.

Among others, examples of machine learning models or neural networks that may be included in the first wireless device 402 include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with an input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. FIG. 4 illustrates that an example neural network 406 may include a network of interconnected nodes. An output of one node is connected as the input to another node. Connections between nodes may be referred to as edges, and weights may be applied to the connections/edges to adjust the output from one node that is applied as the input to another node. Nodes may apply thresholds in order to determine whether, or when, to provide output to a connected node. The output of each node may be calculated as a non-linear function of a sum of the inputs to the node. The neural network 406 may include any number of nodes and any type of connections between nodes. The neural network 406 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times. As an example, the first wireless device 402 may input information 410 to the neural network 406 (e.g., via a task/condition manager 418), and may receive output 412 (e.g., via a controller/processor 420). The first wireless device 402 may report information 414 to the second device 404 based on the output 412. In some aspects, the second device may transmit communication to the first wireless device 402 based on the information 414. In some aspects, the second device 404 may be a base station that schedules or configures a UE (e.g., the first wireless device 402) based on the information 414, e.g., at 416. In other aspects, the base station may collect information from multiple training hosts, e.g., from multiple UEs. Similarly, a network may collect information from multiple training hosts including multiple base stations, multiple IAB nodes, and/or multiple UEs, among other examples.

The first wireless device 402 may be configured to perform aspects in connection with the model grouping component 198 of FIG. 1. For example, the first wireless device 402 may be a first UE or a network component that includes the model grouping component 198 of FIG. 1.

The second wireless device 404 may be configured to perform aspects in connection with the model configuration component 199 of FIG. 1. For example, the second wireless device 404 may be a network or a second UE that includes the model configuration component 199 of FIG. 1.

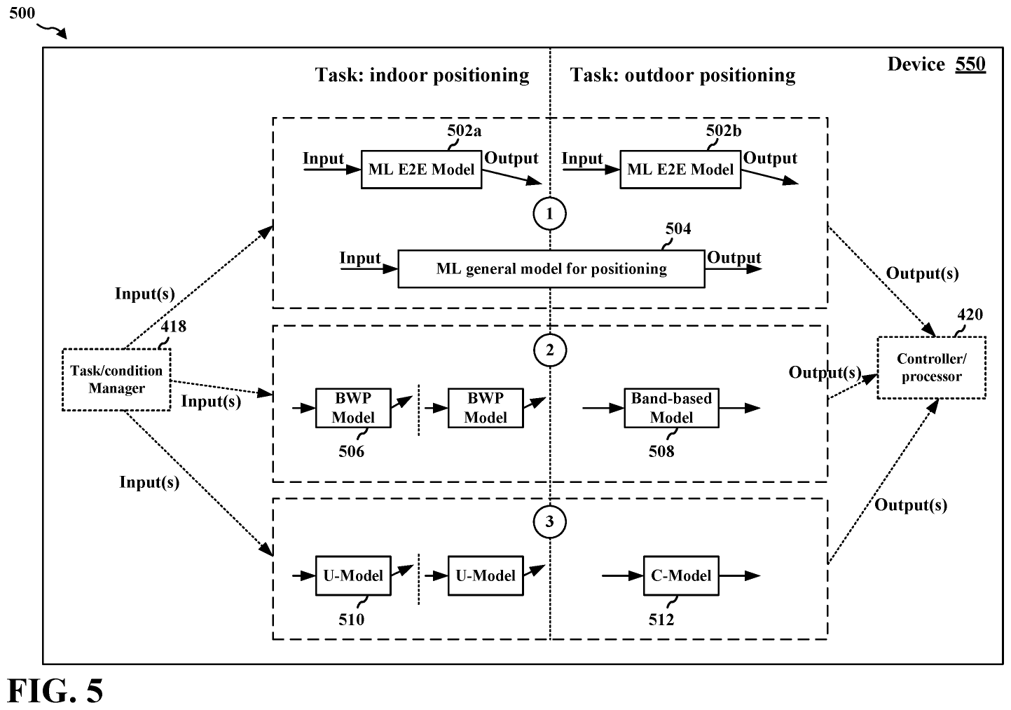

FIG. 5 illustrates an example diagram 500 including different types of ML model structures for a device 550. The device 550 may be a UE, a base station, other network entity, etc. A plurality of ML models may be configured and triggered at a UE for an ML inference procedure. The ML models may correspond to different application functions, UE capabilities, tasks/conditions of the UE, etc. Different ML models may have different performance levels and complexities, such that a same application function or task/condition may be performed by the different ML models. For example, a plurality of ML models may be configured to the UE for a channel state feedback (CSF) task and the UE may select one of the plurality of ML models based on the CSF task.

The selected ML model may be a baseline model, which may be more robust than a specific/dedicated model and may be executed for more tasks/conditions than the specific/dedicated model. For instance, the baseline model may be executed for both indoor tasks and outdoor tasks, for each associated sub-band, etc. An overall complexity of the baseline model may be lower than an overall complexity of the specific/dedicated model. In some cases, the specific/dedicated model may also be referred to as an “advanced model” and may provide an output having an increased performance for a particular condition. For instance, the specific/dedicated model may provide increased performance for indoor positioning tasks, but may not be used for other conditions, and may correspond to increased model complexity in comparison to the baseline model.

ML procedures performed for a particular task/condition may be data-driven. For example, multiple ML models may be learned for a single task based on different performance levels and model complexities. The UE may be configured with the plurality of ML models to adapt to different tasks/conditions. In examples, a positioning task may correspond to multiple ML models configured to the UE. A baseline model, such as an ML general model 504 for positioning, may be used for both the indoor positioning task, the outdoor positioning task, and/or other tasks. Separate specific/dedicated models, such as a first ML end-to-end (E2E) model 502a for the indoor positioning task and a second ML E2E model 502b for the outdoor positioning task may also be configured to the UE for separate tasks.

A baseline model may correspond to a band-based ML model 508 configured for a particular band, whereas a specific/dedicated model may correspond to a BWP model 506 configured per BWP. The band-based ML model 508 or a subband-based model may be more robust than the BWP model 506 and may be executed for more conditions than the BWP model 506. In another example, the baseline model may be a cell-based ML model (C-model) 512 and the specific/dedicated model may be a UE-based ML model (U-model) 510. The C-model 512 for a task/condition may be executed for a plurality of UEs included in a same cell, whereas the U-model 510 for the task/condition may be executed by a particular UE of the cell, such that different UEs of the cell may use a different U-model 510 for the same task/condition. Input(s) for different aspects of the device 550 may be received from the task/condition manager 418 and output(s) from the different aspects of the device 550 may be provided to the controller/processor 420.

Configuring the plurality of ML models for a same or different task/condition may increase signaling overhead for ML inference procedures. For example, if a specific/dedicated model is executed for one task/condition, the UE may have to dynamically switch between the plurality of ML models to adapt to a different task/condition. The ML model switching may be performed from a baseline model to a specific/dedicated model, from a specific/dedicated model to a baseline model, from a first baseline model to a second baseline model, or from a first specific/dedicated model to a second specific/dedicated model. Grouping the ML models into categories for a same task/condition may reduce signaling overhead associated with ML model switching. For example, the plurality of ML models may be allocated into a BMG and an SMG. The ML model groups may be configured and grouped based on one or more protocols.

The UE may switch between ML model groups based on different tasks/conditions of the UE. Such techniques may allow the UE to increase performance while maintaining model complexity. Grouping the ML models may provide a default/initialized ML model configuration, which may trigger ML functions at the UE. Priority protocols may reduce collisions among different ML models for a same task, while providing an adjustable performance level based on the complexity of the ML model via dynamic ML model switching techniques.

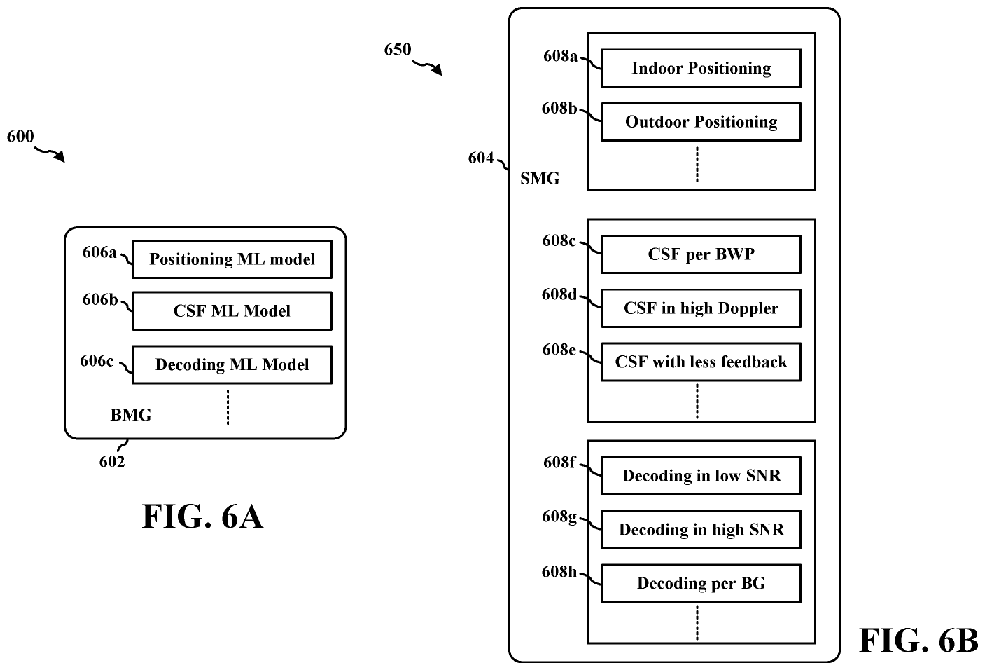

FIGS. 6A-6B are diagrams 600-650 illustrating an allocation of ML models into two groups including the BMG 602 and the SMG 604. The BMG 602 may include ML models (e.g., baseline models) having outputs associated with decreased performance, but being associated with decreased model complexity. ML models in the BMG 602 may be executed for a broader range of tasks and conditions than ML models in the SMG 604. An increased number of UEs of a cell may be configured to execute ML models included in the BMG 602, as ML inference protocols may require execution of such ML models by the UEs. ML models of the BMG 602 may correspond to an initial setting of the UE for ML inference procedures. ML models of the BMG 602 may also be associated with an initial/default setting of the network.

Some ML models, such as specific/dedicated models, may be executed for a particular task or a particular condition. Specific/dedicated models may be included in the SMG 604. ML models included in the SMG 604 may have outputs associated with increased performance, but may also be associated with increased model complexity. Specific/dedicated models may be executed on a task-specific basis or a condition-specific basis. An indicated UE capability may be indicative of whether a UE of the cell is configured to execute specific/dedicated models in the SMG 604. In some instances, UEs may execute a baseline model of the BMG 602, but may not execute a specific/dedicated model of the SMG 604 (e.g., some UEs may not have a capability to execute specific/dedicated models or may just determine to execute a baseline model for a particular task/condition).

Some baseline models included in the BMG 602 may be configured for different tasks/conditions. For example, a first baseline model 606a in the BMG 602 may be configured as a positioning ML model, a second baseline model 606b in the BMG 602 may be configured as a CSF ML model, a third baseline model 606c in the BMG 602 may be configured as a decoding ML model, etc. Thus, for example, the positioning ML model in the BMG 602 may provide a positioning indication/service where the UE does not have to determine a particular application condition associated with the positioning indication/service. The UE may be configured with the BMG 602 during an ML model inference stage, which may provide the baseline models for the UE. While baseline models may provide outputs associated with decreased performance, the baseline models may be of decreased complexity and may include increased robustness for being executed in association with a broader range of tasks/conditions.

The UE may be configured with the SMG 604 based on a capability of the UE. Thus, some UEs may be configured with just the BMG 602 based on the UE capability, while other UEs may be configured with both the BMG 602 and the SMG 604. ML models included in the SMG 604 may be executed for a same task/condition as ML included in the BMG 602. For example, the SMG 604 may include specific/dedicated models that may be dedicated to certain aspects of positioning. That is, the SMG 604 may include separate specific/dedicated models for indoor positioning 608a and outdoor positioning 608b, rather than a single baseline model (e.g., the first baseline model 606a) that may be configured for both indoor positioning and outdoor positioning. Based on the UE capability, a specific/dedicated model in the SMG 604 may be triggered for the indoor positioning 608a or the outdoor positioning 608b to adjust to different tasks/conditions. The SMG 604 may include specific/dedicated models for CSF, such as CSF per BWP 608c, CSF in high Doppler 608d, CSF with decreased feedback 608c, etc. Further, the SMG 604 may include specific/dedicated models for decoding, such as for decoding in low signal-to-noise ratio (SNR) 608f, decoding in high SNR 608g, decoding per base graph (BG) 608h, etc.

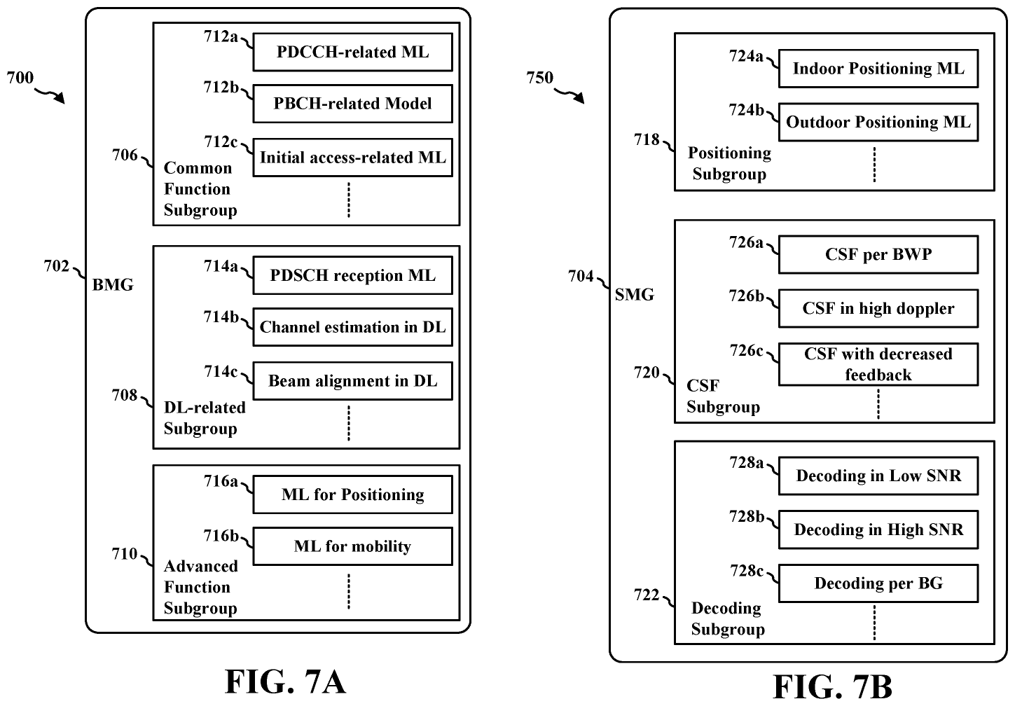

FIGS. 7A-7B are diagrams 700-750 illustrating sub-allocations of ML models into ML model subgroups. For example, first ML models included in the BMG 702 may be sub-allocated into first ML subgroups 706-710 and second ML models included in the SMG 704 may be sub-allocated into second ML model subgroups 718-722. The first ML models of the BMG 702 may be sub-allocated based on different tasks/conditions. For example, the first ML models may be sub-allocated into a common function subgroup 706, which may include first ML models corresponding to PDCCH-related ML 712a, PBCH-related ML 712b, and/or initial access-related ML 712c. In another example, the first ML models may be sub-allocated into a downlink-related subgroup 708, which may include first ML models corresponding to PDSCH reception ML 714a, channel estimation in downlink 714b, and/or beam alignment in downlink 714c. In a further example, the first ML models may be sub-allocated into an advanced function subgroup 710, which may include first ML models corresponding to ML for positioning 716a and/or ML for mobility 716b. The first ML model subgroups 706-710 may also include other additional or alternative types of subgroups.

The second ML models of the SMG 704 may also be sub-allocated based on different tasks/conditions. For example, the second ML models may be sub-allocated into a positioning subgroup 718, which may include second ML models corresponding to indoor positioning ML 724a and/or outdoor positioning ML 724b. In another example, the second ML models may be sub-allocated into a CSF subgroup 720, which may include second ML models corresponding to CSF per BWP 726a, CSF in high Doppler 726b, and/or CSF with decreased feedback 726c. In a further example, the second ML models may be sub-allocated into a decoding subgroup 722, which may include second ML models corresponding to decoding based on low SNR 728a, decoding based on high SNR 728b, and/or decoding per BG 728c. The second ML model subgroups 718-722 may also include other additional or alternative types of subgroups.

During model configuration, one or more of the subgroups 706-710 and 718-722 included in the BMG 702 and/or the SMG 704 may be configured to the UE. The one or more subgroups may correspond to a subset of the subgroups included in the BMG 702 and/or the SMG 704. For example, the UE may be configured based on the BMG 702 but not based on the SMG 704, or the UE may be configured with a subset of the BMG subgroups and/or the SMG subgroups, but not with an overall BMG configuration and/or SMG configuration.

ML model deployment may be based on tradeoffs between a collected dataset for training the ML model, ML model complexity, ML model accuracy, ML model generalized performance, etc. A number of protocols may be defined for grouping the ML models (e.g., given that multiple ML models may correspond to a same task/condition). A first protocol may correspond to grouping the ML models based on the generalized performance of the ML models. ML models in the BMG 702 may be more robust and may be generalized for the different tasks/conditions. ML models in the SMG 704 may be dedicated to a particular task/condition to provide outputs associated with increased performance for the particular task/condition. However, the ML models in the SMG 704 may not be used outside the scope of the particular task/condition. For example, a first ML model that is used for a broad range of positioning tasks may be a baseline model included in the BMG 702. A second ML model dedicated to an indoor positioning task may be a first specific/dedicated model included in the SMG 704. A third ML model dedicated to an outdoor positioning task may be a second specific/dedicated model included in the SMG 704.

A second protocol may correspond to grouping the ML models based on the ML model complexity. The BMG 702 may include ML models (e.g., baseline models) of a decreased overall complexity. The complexity may be determined based on memory characteristics, fixed/floating operations, etc. The “overall complexity” may refer to calculations that are based on all of the applicable conditions for the ML model. If the overall complexity is high, the ML model may be allocated to the SMG 704. In order to support different conditions, the SMG 704 may include many different specific/dedicated models, which may cause the SMG 704 to have a large overall complexity. For an example positioning task, a baseline model configured for a broad range of tasks/conditions may be associated with a memory cost of 5 megabytes (MBs), whereas a first specific/dedicated model for an indoor positioning task may be associated with a memory cost of 4 MBs and a second specific/dedicated model for an outdoor positioning task may be associated with a memory cost of 3 MBs. Accordingly, the baseline model in the BMG 702, which may be configured for both indoor positioning tasks and outdoor positioning tasks, may utilize less memory than the sum of the two separate specific/dedicated models for performing the same indoor and outdoor positioning tasks.

A third protocol may correspond to grouping the ML models based on a default/initial setting. Some baseline models (e.g., models configured for initial access procedures of the UE to a cell, initial BWP parameters, etc.) may be included in the BMG 702 via default/initial settings. Such initial/default settings may not have to be configured based on specific/dedicated models of the SMG 704. Hence, the default/initial settings may not include the specific/dedicated models of the SMG 704. Without an initial configuration for a specific/dedicated model, the UE may utilize initial/default ML models (e.g., included in the BMG 702) for different tasks/conditions. For example, the UE may utilize an initial/default ML model of the BMG 702 for a BWP task/condition.

A fourth protocol may correspond to grouping the ML models based on a cell usage or a UE usage. For example, C-models may be included in the BMG 702 and U-models may be included in the SMG 704. U-models may correspond to UE-specific models or UE group-specific models. Specific/dedicated models in the SMG 704 may be dedicated to a certain geographical area within a cell, whereas baseline models in the BMG 702 may correspond to general ML models for the entire cell. C-models may also be executed without an RRC connection to the UE, whereas U-models may be executed based on the RRC connection. For an example positioning task, a baseline model of the BMG 702 may be used for all of the UEs in the cell. Additionally, specific/dedicated models may be used for particular UEs or particular UE groups associated with different locations in the cell (e.g., within large buildings, at spacious exterior environments, etc.).

A fifth protocol may correspond to grouping the ML models based on a priority of the ML models. Prioritization of the ML models may be based on two priority levels (e.g., high priority and low priority). ML models with low priority may be included in the BMG 702 and ML models with high priority may be included in the SMG 704. A specific/dedicated model may be prioritized over a baseline model if the specific/dedicated model collides in time with the baseline model, or if the baseline model collides in time with the specific/dedicated model. Specific/dedicated models of the SMG 704 and baseline models of the BMG 702 may be periodically triggered based on different periodicities. Alternatively, the baseline models may be dynamically triggered and a baseline mode may be periodically triggered. If a collision occurs between the models, the baseline model may be disabled.

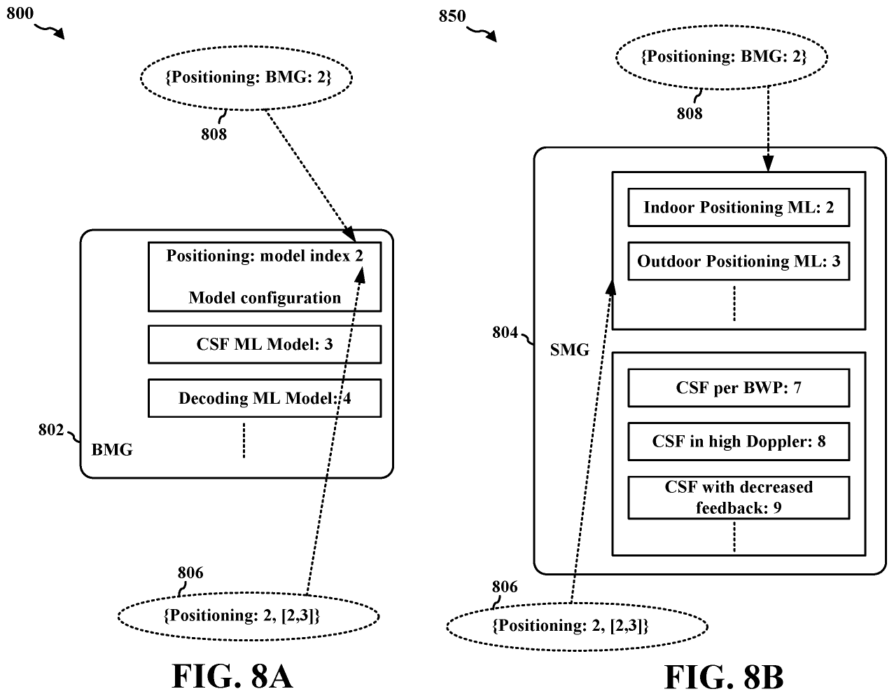

FIGS. 8A-8B are diagrams 800-850 illustrating a joint ML model configuration format 806 and separate ML model configuration formats 808 for the BMG 802 and the SMG 804. In a first aspect, the BMG 802 and the SMG 804 may be configured and triggered based on a joint ML model configuration format 806. In a second aspect, the BMG 802 and the SMG 804 may be configured and triggered based on the separate ML model configuration formats 808.

The network may configure the UE with one ML model from the BMG 802 and one or more ML models from the SMG 804 for performing a single task. A first configuration format may correspond to the joint ML model configuration format 806 (e.g., {Positioning: 2, [2,3]}). The “Positioning” parameter in the joint ML model configuration format 806 may be indicative of a task index, where 2 may correspond to a first model index to the BMG 802 and [2, 3] may correspond to a second model index to the SMG 804. The UE may trigger and use baseline model “2” from the BMG 802 or, based on the UE capability, trigger and use specific/dedicated model [2, 3] from the SMG 804.

A second configuration format may correspond to the separate ML model configuration formats 808, which may be based on independent parameters for the BMG 802 and the SMG 804. For example, the separate ML model configuration formats 808 may include {Positioning: BMG: 2} or {Positioning: SMG: 3}. The “Positioning” parameter in the separate ML model configuration formats 808 may be indicative of a task index, where “BMG” and “SMG” may correspond to a group index, and “2” and “3” may correspond to a model index for a group associated with the group index. In some cases, the “Positioning” task index may be excluded when the model index is associated with a task via predefined mapping procedures.

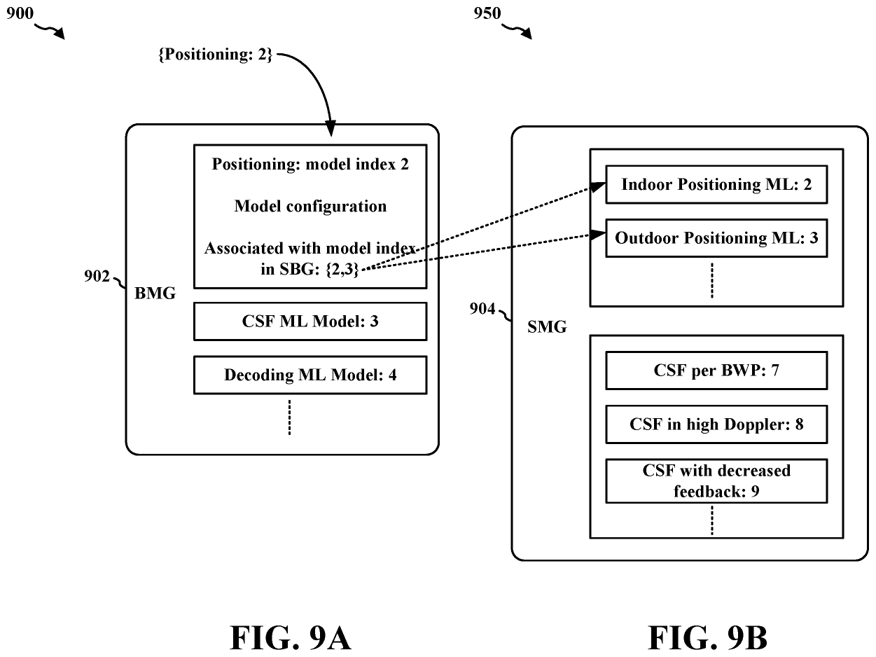

FIGS. 9A-9B are diagrams 900-950 illustrating an association between a baseline model of the BMG 902 and one or more specific/dedicated models of the SMG 904. For joint configuration, the BMG 902 may include baseline models, which may each be associated with one or more specific/dedicated models (or a subgroup of specific/dedicated models) in the SMG 904. The network may configure the baseline models in the BMG 902, but may not explicitly indicate the specific/dedicated models in the SMG 904.

Corresponding models in the SMG 904 may be indicated via the baseline model configuration in the BMG 902. The UE may execute the baseline model and, if the UE determines to provide an output associated with increased performance for a particular task, the UE may download a corresponding specific/dedicated model of the SMG 904 for the particular task based on the index in the baseline model from the BMG 902.

In an example, the network may configure the baseline model from the BMG 902 for positioning based on {P:2}, where “P” correspond to the task index and “2” corresponds to the baseline model index in the BMG 902. The UE may identify a baseline model of the BMG 902 based on the baseline model index, where the baseline model may be associated with/mapped to one or more specific/dedicated models of the SMG 904. For example, the baseline model index “2” may be mapped to a specific/dedicated model index [2, 3]. That is, in addition to the baseline model configuration, the baseline model index may be indicative of an associated specific/dedicated model index {2,3} in the SMG 904. Thus, the UE may determine the indexed specific/dedicated model to configure from the SMG 904. In some cases, the task index “P” may be excluded, as the model index “2” may correspond to a predefined model index determined via predefined protocols.

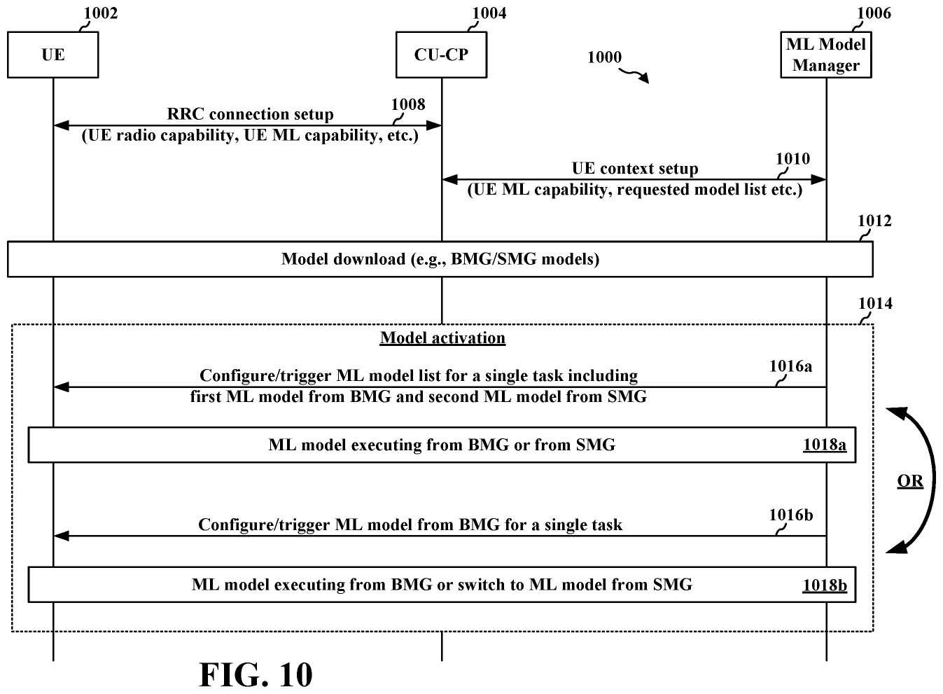

FIG. 10 is a call flow diagram 1000 illustrating communications between a UE 1002 and a network including a centralized unit-control plane (CU-CP) 1004 and an ML model manager 1006. An RRC connection may be established between the UE 1002 and the network (e.g., CU-CP 1004) to provide a configuration for ML model deployment. For example, the UE 1002 may perform, at 1008, an RRC connection setup with the CU-CP 1004. The RRC connection setup, at 1008, may be indicative of a UE radio capability, a UE ML capability, etc. The CU-CP 1004 may transmit, at 1010, a UE context setup request to the ML model manager 1006. The transmitted request may be indicative of the UE ML capability, a requested model list, etc.

At 1012, the UE 1002 may perform an ML model download procedure with the network. The network may configure one or more ML models at a designated node in the network, such as at the ML model manager 1006. The UE 1002 may download, at 1012, the one or more ML models from the designated node in the network (e.g., from the ML model manager 1006 via the CU-CP 1004). That is, the UE 1002 may download, at 1012, BMG models and/or SMG models.

Inference procedures may be performed based on BMG and SMG configuration groups. The BMG and the SMG may be activated, at 1014, based on two separate procedures. In a first example, the network may indicate (e.g., from an ML model list) the specific/dedicated model or the baseline model to be used by the UE. For instance, at 1016a, the ML model manager 1006 may configure/trigger an ML model list for an individual task, where the ML model list may be indicative of a first ML model from the BMG and a second ML model from the SMG. At 1018a, an ML model may be executed from the BMG or from the SMG.

In a second example, the SMG may be associated with the BMG. For instance, at 1016b, the ML model manager 1006 may configure/trigger an ML model from the BMG for an individual task. That is, the network may indicate a baseline model from the BMG for the UE 1002 to initially execute in association with the BMG. The UE 1002 may subsequently determine to switch to a specific/dedicated model from the SMG to provide an output having improved performance. Hence, at 1018b, an ML model may be executed from the BMG or the switched to an ML model from the SMG. The SMG may be associated with an empty field for low complexity UEs, which may be based on the UE capability. That is, the SMG may not be configured for some low complexity UEs.

UE capability reporting may be used for UE capability grouping. A UE capability report (e.g., transmitted at 1008) may be indicative of a first UE capability level configured for ML models in the BMG, but not for ML models in the SMG. Alternatively, the UE capability report (e.g., transmitted at 1008) may be indicative of a second UE capability level configured for ML models in both the BMG and the SMG.

In an example, the UE capability report transmitted, at 1008, may include bit 01, which may indicate that the UE 1002 is configured for ML models in the BMG, but not for ML models in the SMG. Alternatively, the UE capability report transmitted, at 1008, may include bit 10, which may indicate that the UE 1002 is configured for ML models in the BMG and at least some of the ML models in the SMG. ML models from the BMG may correspond to a default configuration of the UE 1002. Without a dedicated configuration, the UE 1002 may select an ML model from the BMG (e.g., during an initialization procedure, such as accessing a cell or utilizing a default BWP.

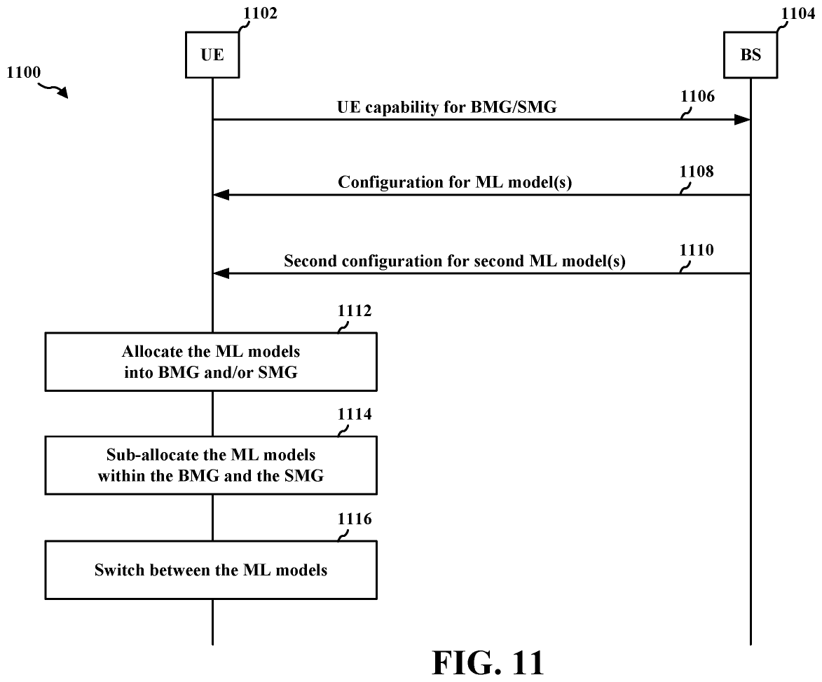

FIG. 11 is a call flow diagram 1100 illustrating communications between a UE 1102 and a base station 1104. At 1106, the UE may report a UE capability for BMG/SMG to the base station 1104. The UE capability may be associated with a UE radio capability, a UE ML capability, etc.

At 1108, the base station 1104 may transmit a configuration for ML model(s) to the UE 1102. The configuration may be associated with at least one task/condition for execution of the ML model(s). At 1110, the base station 1104 may transmit a second configuration for second ML models(s) to the UE 1102. In examples, the configuration transmitted, at 1108, may be for baseline models of the BMG and the second configuration transmitted, at 1110, may be for specific/dedicated models of the SMG.

At 1112, the UE 1102 may allocate the ML models into the BMG and/or the SMG. Allocation, at 1112, of the ML models into the SMG may be based on the UE capability reported, at 1106, to the base station 1104. At 1114, the UE 1102 may sub-allocate the ML models within the BMG and the SMG. For example, ML models within the BMG may be sub-allocated to a common function subgroup, a downlink/uplink subgroup, an advanced function subgroup, etc. ML models within the SMG may be sub-allocated to a positioning subgroup, a CSF subgroup, a decoding subgroup, etc.

At 1116, the UE may switch between the ML models allocated, at 1112, to the BMG and/or the SMG. The UE may also switch, at 1116, between the ML models sub-allocated, at 1114, within the BMG and/or the SMG. For instance, the UE 1102 may switch from a first baseline model of the BMG to a second baseline model of the BMG, switch from a baseline model of the BMG to a specific/dedicated model of the SMG, switch from a specific/dedicated model of the SMG to a baseline model of the BMG, or switch from a first specific/dedicated model of the SMG to a second specific/dedicated model of the SMG.

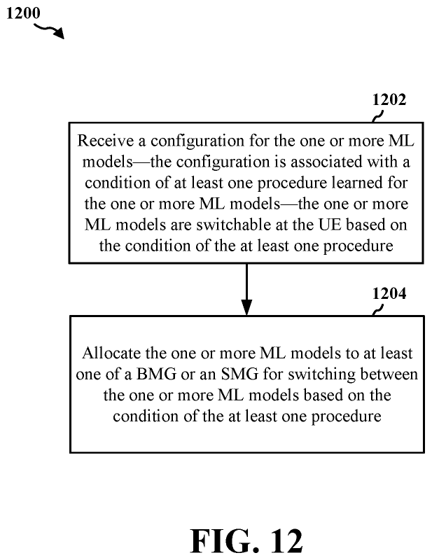

FIG. 12 is a flowchart 1200 of a method of wireless communication. The method may be performed by a UE (e.g., the UE 104, 402, 1002, 1102; the apparatus 1602; etc.), which may include the memory 360 and which may be the entire UE 104, 402, 1002, 1102 or a component of the UE 104, 402, 1002, 1102, such as the TX processor 368, the RX processor 356, and/or the controller/processor 359. The method may be performed to reduce signaling costs for ML inference procedures.

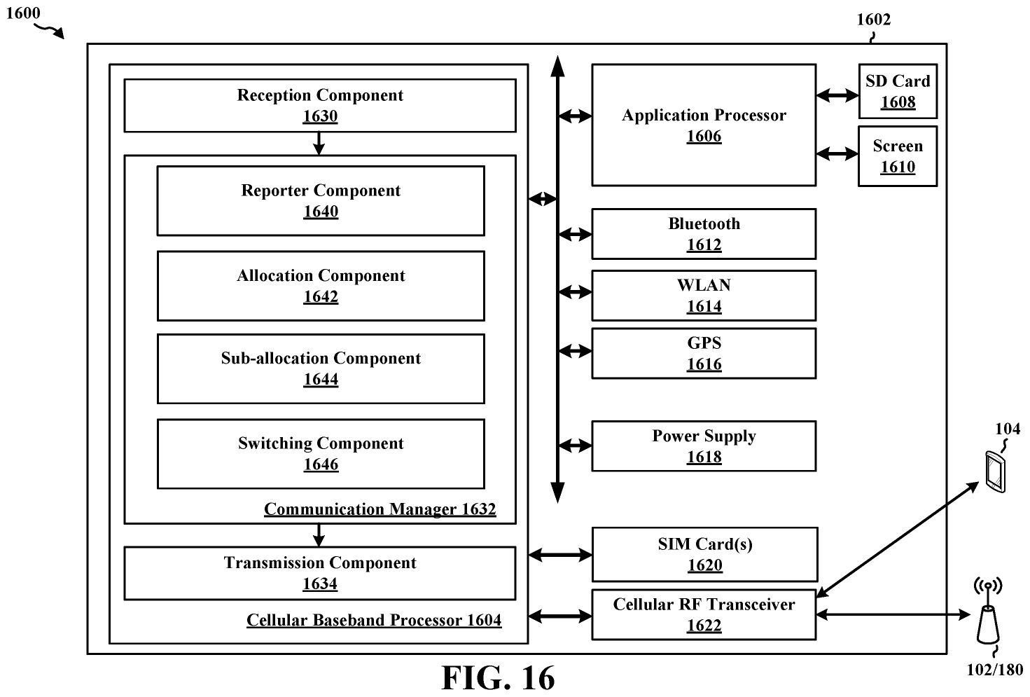

At 1202, the UE may receive a configuration for the one or more ML models—the configuration is associated with a condition of at least one procedure learned for the one or more ML models—the one or more ML models are switchable at the UE based on the condition of the at least one procedure. For example, referring to FIG. 11, the UE 1102 may receive, at 1108, a configuration for ML model(s) from the base station 1104. The UE 1102 may be configured to switch between the ML models (e.g., at 1116). The reception, at 1202, may be performed by the reception component 1630 of the apparatus 1602 in FIG. 16.

At 1204, the UE may allocate the one or more ML models to at least one of a BMG or an SMG for switching between the one or more ML models based on the condition of the at least one procedure. For example, referring to FIGS. 6 and 11, the UE 1102 may allocate, at 1112, the ML models into the BMG and/or the SMG, such that the UE 1102 may switch, at 1116, between the ML models allocated into the BMG and/or the SMG. The diagram 600 similarly illustrates the allocation of the ML models into the BMG 602 and the SMG 604. The allocation, at 1204, may be performed by the allocation component 1642 of the apparatus 1602 in FIG. 16.

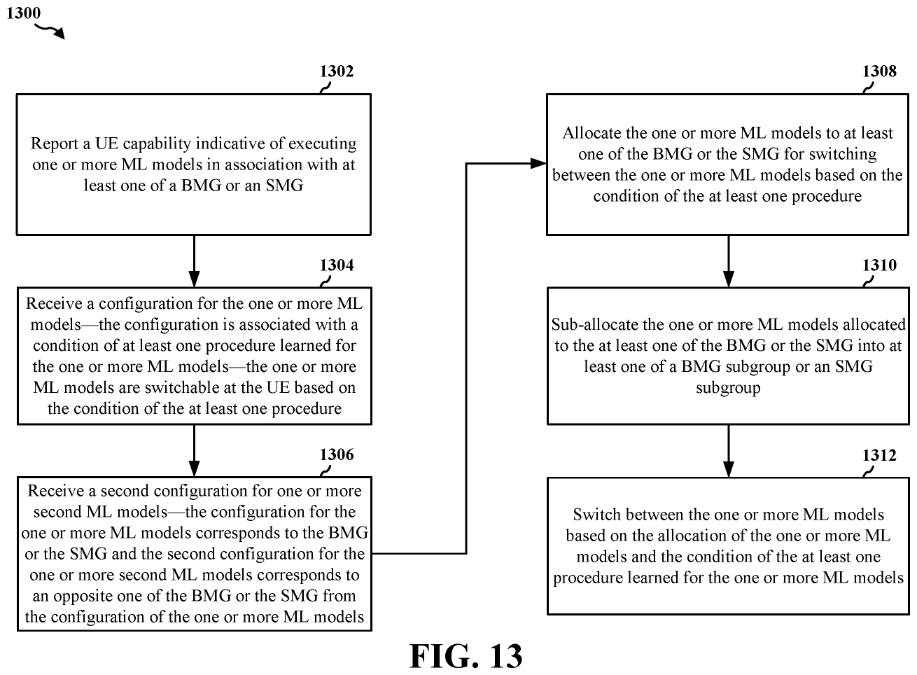

FIG. 13 is a flowchart 1300 of a method of wireless communication. The method may be performed by a UE (e.g., the UE 104, 402, 1002, 1102; the apparatus 1602; etc.), which may include the memory 360 and which may be the entire UE 104, 402, 1002, 1102 or a component of the UE 104, 402, 1002, 1102, such as the TX processor 368, the RX processor 356, and/or the controller/processor 359. The method may be performed to reduce signaling costs for ML inference procedures.

At 1302, the UE may report a UE capability indicative of executing one or more ML models in association with at least one of a BMG or an SMG. For example, referring to FIGS. 10-11, the UE 1102 may report, at 1106, a UE capability for the BMG/SMG to the base station 1104. In the diagram 1000, the UE may report, at 1008, a UE radio capability, a UE ML capability, etc., to the CU-CP 1004 during an RRC connection setup procedure. The reporting, at 1302, may be performed by the reporter component 1640 of the apparatus 1602 in FIG. 16.

At 1304, the UE may receive a configuration for the one or more ML models—the configuration is associated with a condition of at least one procedure learned for the one or more ML models—the one or more ML models are switchable at the UE based on the condition of the at least one procedure. For example, referring to FIG. 11, the UE 1102 may receive, at 1108, a configuration for ML model(s) from the base station 1104. The UE 1102 may be configured to switch between the ML models (e.g., at 1116). The configuration received, at 1108, for the one or more ML model(s) may correspond to the BMG and each of the one or more ML model(s) corresponding to the BMG may be indexed to one or more second ML models corresponding to the SMG. The reception, at 1304, may be performed by the reception component 1630 of the apparatus 1602 in FIG. 16.

At 1306, the UE may receive a second configuration for one or more second ML models—the configuration for the one or more ML models corresponds to the BMG or the SMG and the second configuration for the one or more second ML models corresponds to an opposite one of the BMG or the SMG from the configuration of the one or more ML models. For example, referring to FIG. 11, the UE 1102 may receive, at 1110, a second configuration for second ML model(s) from the base station 1104. The second ML model(s) (e.g., specific/dedicated models of the SMG) received, at 1110, from the base station 1104 may be different from the ML model(s) (e.g., baseline models of the BMG) received, at 1108, from the base station 1104. The reception, at 1306, may be performed by the reception component 1630 of the apparatus 1602 in FIG. 16.

At 1308, the UE may allocate the one or more ML models to at least one of the BMG or the SMG for switching between the one or more ML models based on the condition of the at least one procedure. For example, referring to FIGS. 6 and 11, the UE 1102 may allocate, at 1112, the ML models into the BMG and/or the SMG, such that the UE 1102 may switch, at 1116, between the ML models allocated into the BMG and/or the SMG. The diagram 600 similarly illustrates the allocation of the ML models into the BMG 602 and the SMG 604. The one or more ML models allocated (e.g., at 1112) to the BMG may correspond to initialized ML models of a first complexity and a first performance, and the one or more ML models allocated (e.g., at 1112) to the SMG may correspond to dedicated ML models of a second complexity and a second performance that are higher than the first complexity and the first performance. The allocation, at 1112, of the one or more ML models may include allocating the configuration for the one or more ML models to the BMG based on an ML inference and the one or more ML models to the SMG based on a UE capability. The allocation, at 1308, may be performed by the allocation component 1642 of the apparatus 1602 in FIG. 16.

In a first aspect, allocating the one or more ML models, at 1112, may include allocating the one or more ML models to the at least one of the BMG or the SMG based on a performance associated with the one or more ML models, where the one or more ML models may be allocated, at 1112, to the BMG based on a robust performance for a plurality of conditions including the condition of the at least one procedure and the one or more ML models may be allocated, at 1112, to the SMG based on a dedicated performance to the condition of the at least one procedure. In a second aspect, the allocation of the one or more ML models may include allocating, at 1112, the one or more ML models to the at least one of the BMG or the SMG based on a complexity of the one or more ML models, where the one or more ML models may be allocated, at 1112, to the BMG based on a first complexity and the one or more ML models may be allocated, at 1112, to the SMG based on a second complexity that is higher than the first complexity. In a third aspect, the allocation of the one or more ML models may include allocating, at 1112, the one or more ML models to the at least one of the BMG or the SMG based on an initialization event, where the allocation, at 1112, of the one or more ML models to the BMG may occur at a time of the initialization event and the allocation, at 1112, of the one or more ML models to the SMG may occur after the time of the initialization event. In a fourth aspect, allocating the one or more ML models, at 1112, may include allocating the one or more ML models to the at least one of the BMG or the SMG based on an application of the one or more ML models, where the allocation, at 1112, to the BMG may correspond to a cell-specific application and the allocation, at 1112, to the SMG may correspond to at least one of a UE-specific application or a UE group-specific application. In a fifth aspect, the allocating the one or more ML models, at 1112, may include allocating the one or more ML models to the at least one of the BMG or the SMG based on a priority level of the one or more ML models, where the allocation, at 1112, to the BMG may correspond to first ML models of a first priority level and the allocation, at 1112, to the SMG may correspond to second ML models of a second priority level that is higher than the first priority level.

At 1310, the UE may sub-allocate the one or more ML models allocated to the at least one of the BMG or the SMG into at least one of a BMG subgroup or an SMG subgroup. For example, referring to FIGS. 7 and 11, the UE 1102 may sub-allocate, at 1114, the ML models within the BMG and/or the SMG. The diagram 700 similarly illustrates sub-allocation of the ML models within the BMG 702 and the SMG 704. The sub-allocation, at 1310, may be performed by the sub-allocation component 1644 of the apparatus 1602 in FIG. 16.

At 1312, the UE may switch between the one or more ML models based on the allocation of the one or more ML models and the condition of the at least one procedure learned for the one or more ML models. For example, referring to FIGS. 10-11, the UE 1102 may switch, at 1116, between the ML models. Further, at 1018b, the UE 1002 may switch from an ML model executing from the BMG to a different ML model from the SMG. The switching, at 1312, may be performed by the switching component 1646 of the apparatus 1602 in FIG. 16.

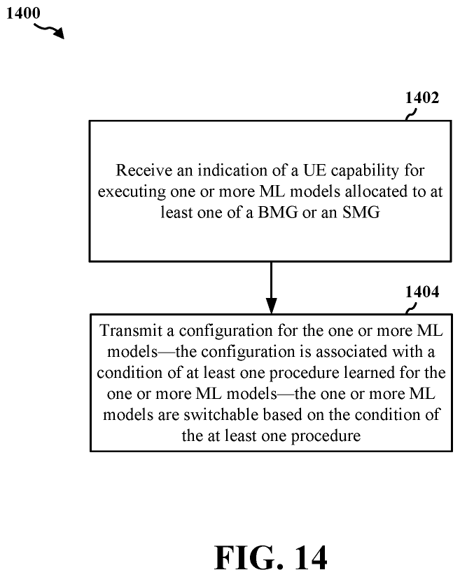

FIG. 14 is a flowchart 1400 of a method of wireless communication. The method may be performed by a base station (e.g., the base station 102, 1104; the second device 404; the network including the CU-CP 1004 and the ML model manager 1006; the apparatus 1702; etc.), which may include the memory 376 and which may be the entire base station 102, 1104 or a component of the base station 102, 1104, such as the TX processor 316, the RX processor 370, and/or the controller/processor 375. The method may be performed to reduce signaling costs for ML inference procedures.

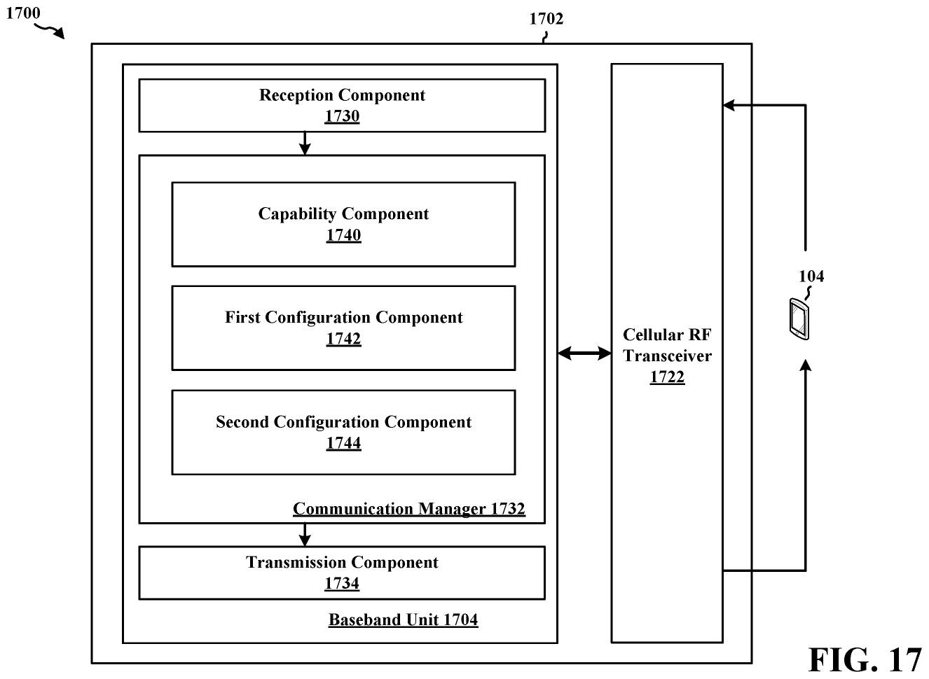

At 1402, the base station may receive an indication of a UE capability for executing one or more ML models allocated to at least one of a BMG or an SMG. For example, referring to FIGS. 10-11, the base station 1104 may receive, at 1106, a UE capability for the BMG/SMG from the UE 1102. In the diagram 1000, the CU-CP 1004 may receive, at 1008, a UE radio capability, a UE ML capability, etc., from the UE 1002 during an RRC connection setup procedure. The reception, at 1402, may be performed by the capability component 1740 of the apparatus 1702 in FIG. 17.

At 1404, the base station may transmit a configuration for the one or more ML models—the configuration is associated with a condition of at least one procedure learned for the one or more ML models—the one or more ML models are switchable based on the condition of the at least one procedure. For example, referring to FIG. 11, the base station 1104 may transmit, at 1108, a configuration for ML model(s) to the UE 1102, which may be configured to switch between the ML models (e.g., at 1116). The transmission, at 1404, may be performed by the first configuration component 1742 of the apparatus 1702 in FIG. 17.

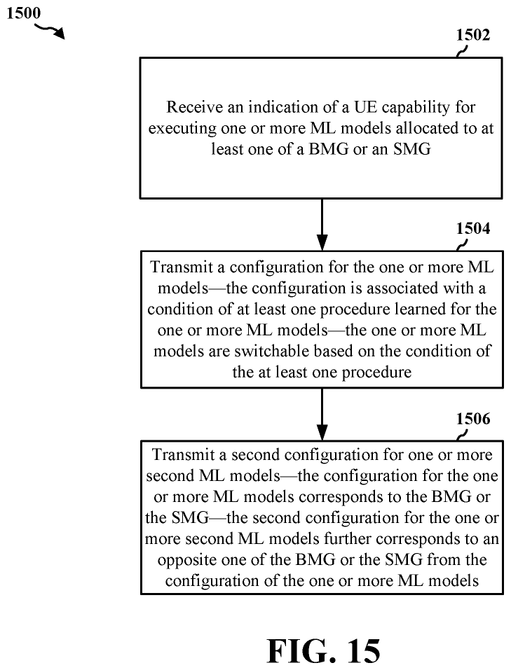

FIG. 15 is a flowchart 1500 of a method of wireless communication. The method may be performed by a base station (e.g., the base station 102, 1104; the second device 404; the network including the CU-CP 1004 and the ML model manager 1006; the apparatus 1702; etc.), which may include the memory 376 and which may be the entire base station 102, 1104 or a component of the base station 102, 1104, such as the TX processor 316, the RX processor 370, and/or the controller/processor 375. The method may be performed to reduce signaling costs for ML inference procedures.

At 1502, the base station may receive an indication of a UE capability for executing one or more ML models allocated to at least one of a BMG or an SMG. For example, referring to FIGS. 10-11, the base station 1104 may receive, at 1106, a UE capability for the BMG/SMG from the UE 1102. In the diagram 1000, the CU-CP 1004 may receive, at 1008, a UE radio capability, a UE ML capability, etc., from the UE 1002 during an RRC connection setup procedure. The one or more ML models allocated (e.g., at 1112) to the BMG may correspond to initialized ML models of a first complexity and a first performance, and the one or more ML models allocated (e.g., at 1112) to the SMG may correspond to dedicated ML models of a second complexity and a second performance that are higher than the first complexity and the first performance. The configuration transmitted, at 1108, for the one or more ML models (e.g., allocated to the BMG) may be based on an ML inference, and the second configuration transmitted, at 1110, for the one or more ML models (e.g., allocated to the SMG) may be based on the UE capability received, at 1106. The one or more ML models may be sub-allocated within the at least one of the BMG 702 or the SMG 704 (e.g., based on the diagram 700) to at least one of a BMG subgroup or an SMG subgroup. The diagram 700 illustrates that the BMG subgroup may correspond to at least one of a common function subgroup 706, a downlink-related subgroup 708, or an advanced function subgroup 710. The diagram 700 illustrates that the SMG subgroup may correspond to at least one of a positioning subgroup 718, a CSF subgroup 720, or a decoding subgroup 722. The reception, at 1502, may be performed by the capability component 1740 of the apparatus 1702 in FIG. 17.

In a first aspect, allocating the one or more ML models, at 1112, may include allocating the one or more ML models to the at least one of the BMG or the SMG based on a performance associated with the one or more ML models, where the one or more ML models may be allocated, at 1112, to the BMG based on a robust performance for a plurality of conditions including the condition of the at least one procedure and the one or more ML models may be allocated, at 1112, to the SMG based on a dedicated performance to the condition of the at least one procedure. In a second aspect, the allocation of the one or more ML models may include allocating, at 1112, the one or more ML models to the at least one of the BMG or the SMG based on a complexity of the one or more ML models, where the one or more ML models may be allocated, at 1112, to the BMG based on a first complexity and the one or more ML models may be allocated, at 1112, to the SMG based on a second complexity that is higher than the first complexity. In a third aspect, the allocation of the one or more ML models may include allocating, at 1112, the one or more ML models to the at least one of the BMG or the SMG based on an initialization event, where the allocation, at 1112, of the one or more ML models to the BMG may occur at a time of the initialization event and the allocation, at 1112, of the one or more ML models to the SMG may occur after the time of the initialization event. In a fourth aspect, allocating the one or more ML models, at 1112, may include allocating the one or more ML models to the at least one of the BMG or the SMG based on an application of the one or more ML models, where the allocation, at 1112, to the BMG may correspond to a cell-specific application and the allocation, at 1112, to the SMG may correspond to at least one of a UE-specific application or a UE group-specific application. In a fifth aspect, the allocating the one or more ML models, at 1112, may include allocating the one or more ML models to the at least one of the BMG or the SMG based on a priority level of the one or more ML models, where the allocation, at 1112, to the BMG may correspond to first ML models of a first priority level and the allocation, at 1112, to the SMG may correspond to second ML models of a second priority level that is higher than the first priority level.

At 1504, the base station may transmit a configuration for the one or more ML models—the configuration is associated with a condition of at least one procedure learned for the one or more ML models—the one or more ML models are switchable based on the condition of the at least one procedure. For example, referring to FIG. 11, the base station 1104 may transmit, at 1108, a configuration for ML model(s) to the UE 1102, which may be configured to switch between the ML models (e.g., at 1116). The configuration transmitted, at 1108, for the one or more ML models may correspond to the BMG, and each of the one or more ML models corresponding to the BMG may be indexed to one or more second ML models corresponding to the SMG. The transmission, at 1504, may be performed by the first configuration component 1742 of the apparatus 1702 in FIG. 17.

At 1506, the base station may transmit a second configuration for one or more second ML models—the configuration for the one or more ML models corresponds to the BMG or the SMG—the second configuration for the one or more second ML models further corresponds to an opposite one of the BMG or the SMG from the configuration of the one or more ML models. For example, referring to FIG. 11, the base station 1104 may transmit, at 1110, a second configuration for second ML model(s) to the UE 1102. The second ML model(s) (e.g., specific/dedicated models of the SMG) transmitted, at 1110, to the UE 1102 may be different from the ML model(s) (e.g., baseline models of the BMG) transmitted, at 1108, to the UE 1102. The transmission, at 1506, may be performed by the second configuration component 1744 of the apparatus 1702 in FIG. 17.

FIG. 16 is a diagram 1600 illustrating an example of a hardware implementation for an apparatus 1602. The apparatus 1602 may be a UE, a component of a UE, or may implement UE functionality. In some aspects, the apparatus 1602 may include a cellular baseband processor 1604 (also referred to as a modem) coupled to a cellular RF transceiver 1622. In some aspects, the apparatus 1602 may further include one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, or a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The reception component 1630 is configured, e.g., as described in connection with 1202, 1304, and 1306, to receive a configuration for the one or more ML models the configuration is associated with a condition of at least one procedure learned for the one or more ML models—the one or more ML models are switchable at the UE based on the condition of the at least one procedure; and to receive a second configuration for one or more second ML models—the configuration for the one or more ML models corresponds to the BMG or the SMG and the second configuration for the one or more second ML models corresponds to an opposite one of the BMG or the SMG from the configuration of the one or more ML models.

The communication manager 1632 includes a reporter component 1640 that is configured, e.g., as described in connection with 1302, to report a UE capability indicative of executing one or more ML models in association with at least one of a BMG or an SMG. The communication manager 1632 further includes an allocation component 1642 that is configured, e.g., as described in connection with 1204 and 1308, to allocate the one or more ML models to at least one of the BMG or the SMG for switching between the one or more ML models based on the condition of the at least one procedure. The communication manager 1632 further includes a sub-allocation component 1644 that is configured, e.g., as described in connection with 1310, to sub-allocate the one or more ML models allocated to the at least one of the BMG or the SMG into at least one of a BMG subgroup or an SMG subgroup. The communication manager 1632 further includes a switching component 1646 that is configured, e.g., as described in connection with 1312, to switch between the one or more ML models based on the allocation of the one or more ML models and the condition of the at least one procedure learned for the one or more ML models.

The apparatus may include additional components that perform each of the blocks of the algorithm in the flowcharts of FIGS. 12-13. As such, each block in the flowcharts of FIGS. 12-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the cellular baseband processor 1604, includes means for receiving a configuration for one or more ML models, the configuration associated with a condition of at least one procedure learned for the one or more ML models, the one or more ML models being switchable at the UE based on the condition of the at least one procedure; and means for allocating the one or more ML models to at least one of a BMG or an SMG for switching between the one or more ML models based on the condition of the at least one procedure. The apparatus 1602 further includes means for sub-allocating the one or more ML models allocated to the at least one of the BMG or the SMG into at least one of a BMG subgroup or an SMG subgroup, the BMG subgroup corresponding to at least one of a common function subgroup, a downlink/uplink subgroup, or an advanced function subgroup, the SMG subgroup corresponding to at least one of a positioning subgroup, a CSF subgroup, or a decoding subgroup. The apparatus 1602 further includes means for receiving a second configuration for one or more second ML models, the configuration for the one or more ML models corresponding to the BMG or the SMG, the second configuration for the one or more second ML models corresponding to an opposite one of the BMG or the SMG from the configuration of the one or more ML models. The apparatus 1602 further includes means for reporting a UE capability indicative of executing the one or more ML models in association with the at least one of the BMG or the SMG. The apparatus 1602 further includes means for switching between the one or more ML models based on the allocation of the one or more ML models and the condition of the at least one procedure learned for the one or more ML models.

The means for allocating the one or more ML models are further configured to allocate the configuration for the one or more ML models to the BMG based on an ML inference and the one or more ML models to the SMG based on a UE capability. The means for allocating the one or more ML models are further configured to allocate the one or more ML models to the at least one of the BMG or the SMG based on a performance associated with the one or more ML models, the one or more ML models allocated to the BMG based on a robust performance for a plurality of conditions including the condition of the at least one procedure, the one or more ML models allocated to the SMG based on a dedicated performance to the condition of the at least one procedure. The means for allocating the one or more ML models are further configured to allocate the one or more ML models to the at least one of the BMG or the SMG based on a complexity of the one or more ML models, the one or more ML models allocated to the BMG based on a first complexity, the one or more ML models allocated to the SMG based on a second complexity that is higher than the first complexity. The means for allocating the one or more ML models are further configured to allocate the one or more ML models to the at least one of the BMG or the SMG based on an initialization event, the allocation of the one or more ML models to the BMG occurring at a time of the initialization event, the allocation of the one or more ML models to the SMG occurring after the time of the initialization event. The means for allocating the one or more ML models are further configured to allocate the one or more ML models to the at least one of the BMG or the SMG based on an application of the one or more ML models, the BMG corresponding to a cell-specific application, the SMG corresponding to at least one of a UE-specific application or a UE group-specific application. The means for allocating the one or more ML models are further configured to allocate the one or more ML models to the at least one of the BMG or the SMG based on a priority level of the one or more ML models, the BMG corresponding to first ML models of a first priority level, the SMG corresponding to second ML models of a second priority level that is higher than the first priority level.

The means may be one or more of the components of the apparatus 1602 configured to perform the functions recited by the means. As described supra, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 17 is a diagram 1700 illustrating an example of a hardware implementation for an apparatus 1702. The apparatus 1702 may be a base station, a component of a base station, or may implement base station functionality. In some aspects, the apparatus 1602 may include a baseband unit 1704. The baseband unit 1704 may communicate through a cellular RF transceiver 1722 with the UE 104. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of the base station 310 and may include the memory 376 and/or at least one of the TX processor 316, the RX processor 370, and the controller/processor 375.

The communication manager 1732 includes a capability component 1740 that is configured, e.g., as described in connection with 1402 and 1502, to receive an indication of a UE capability for executing one or more ML models allocated to at least one of a BMG or an SMG. The communication manager 1732 further includes a first configuration component 1742 that is configured, e.g., as described in connection with 1404 and 1504, to transmit a configuration for the one or more ML models—the configuration is associated with a condition of at least one procedure learned for the one or more ML models—the one or more ML models are switchable based on the condition of the at least one procedure. The communication manager 1732 further includes a second configuration component 1744 that is configured, e.g., as described in connection with 1506, to transmit a second configuration for one or more second ML models—the configuration for the one or more ML models corresponds to the BMG or the SMG—the second configuration for the one or more second ML models further corresponds to an opposite one of the BMG or the SMG from the configuration of the one or more ML models.

The apparatus may include additional components that perform each of the blocks of the algorithm in the flowcharts of FIGS. 14-15. As such, each block in the flowcharts of FIGS. 14-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the baseband unit 1704, includes means for receiving an indication of a UE capability for executing one or more ML models allocated to at least one of a BMG or an SMG; and means for transmitting a configuration for the one or more ML models, the configuration associated with a condition of at least one procedure learned for the one or more ML models, the one or more ML models being switchable based on the condition of the at least one procedure. The apparatus 1702 further includes means for transmitting a second configuration for one or more second ML models, the configuration for the one or more ML models corresponding to the BMG or the SMG, the second configuration for the one or more second ML models corresponding to an opposite one of the BMG or the SMG from the configuration of the one or more ML models.

The means may be one or more of the components of the apparatus 1702 configured to perform the functions recited by the means. As described supra, the apparatus 1702 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE including receiving a configuration for one or more ML models, the configuration associated with at least one of a task or a condition of at least one procedure of the UE; and allocating the one or more ML models to at least one of a BMG or a SMG for switching between the one or more ML models based on the at least one of the task or the condition of the at least one procedure of the UE.

Aspect 2 may be combined with aspect 1 and includes that the one or more ML models allocated to the BMG correspond to first ML models of a first complexity and a first performance.

Aspect 3 may be combined with any of aspects 1-2 and includes that the one or more ML models allocated to the SMG correspond to second ML models of a second complexity and a second performance that are higher than the first complexity and the first performance.

Aspect 4 may be combined with any of aspects 1-3 and includes that the one or more ML models are allocated to the BMG based on an ML inference.

Aspect 5 may be combined with any of aspects 1-4 and includes that the one or more ML models are allocated to the SMG based on a UE capability.

Aspect 6 may be combined with any of aspects 1-5 and further includes sub-allocating the one or more ML models allocated to the at least one of the BMG or the SMG into at least one of a BMG subgroup or an SMG subgroup.

Aspect 7 may be combined with any of aspects 1-6 and includes that the BMG subgroup corresponds to at least one of a common function subgroup, a downlink/uplink subgroup, or an advanced function subgroup.

Aspect 8 may be combined with any of aspects 1-7 and includes that the SMG subgroup corresponds to at least one of a positioning subgroup, a CSF subgroup, or a decoding subgroup.

Aspect 9 may be combined with any of aspects 1-8 and includes that the one or more ML models are allocated to the at least one of the BMG or the SMG based on a performance associated with the one or more ML models.

Aspect 10 may be combined with any of aspects 1-9 and includes that the one or more ML models are allocated to the BMG based on a first performance associated with a plurality of tasks.

Aspect 11 may be combined with any of aspects 1-10 and includes that the one or more ML models are allocated to the SMG based on a second performance associated with a single task.

Aspect 12 may be combined with any of aspects 1-8 and includes that the one or more ML models are allocated to the at least one of the BMG or the SMG based on a complexity of the one or more ML models.

Aspect 13 may be combined with any of aspects 1-8 and 12 and includes that the one or more ML models are allocated to the BMG based on a first complexity.

Aspect 14 may be combined with any of aspects 1-8 and 12-13 and includes that the one or more ML models are allocated to the SMG based on a second complexity that is higher than the first complexity.

Aspect 15 may be combined with any of aspects 1-8 and includes that the one or more ML models are allocated to the at least one of the BMG or the SMG based on an initialization time of the UE.

Aspect 16 may be combined with any of aspects 1-8 and 15 and includes that the one or more ML models are allocated to the BMG at the initialization time of the UE. Aspect 17 may be combined with any of aspects 1-8 and 15-16 and includes that the one or more ML models are allocated to the SMG after the initialization time of the UE.

Aspect 18 may be combined with any of aspects 1-8 and includes that the one or more ML models are allocated to the at least one of the BMG or the SMG based on an application of the one or more ML models.

Aspect 19 may be combined with any of aspects 1-8 and 18 and includes that the BMG corresponds to a cell-specific application.

Aspect 20 may be combined with any of aspects 1-8 and 18-19 and includes that the SMG corresponds to at least one of a UE-specific application or a UE group-specific application.

Aspect 21 may be combined with any of aspects 1-8 and includes that the one or more ML models are allocated to the at least one of the BMG or the SMG based on a priority level of the one or more ML models.

Aspect 22 may be combined with any of aspects 1-8 and 21 and includes that the BMG corresponds to a first ML model of a first priority level.

Aspect 23 may be combined with any of aspects 1-8 and 21-22 and includes that the SMG corresponds to a second ML model of a second priority level that is higher than the first priority level.

Aspect 24 may be combined with any of aspects 1-23 and further includes receiving a second configuration for one or more second ML models.

Aspect 25 may be combined with any of aspects 1-24 and includes that the configuration for the one or more ML models corresponds to the BMG or the SMG.

Aspect 26 may be combined with any of aspects 1-25 and includes that the second configuration for the one or more second ML models corresponds to an opposite one of the BMG or the SMG from the configuration of the one or more ML models.

Aspect 27 may be combined with any of aspects 1-21 and includes that the configuration for the one or more ML models corresponds to the BMG.

Aspect 28 may be combined with any of aspects 1-21 and 27 and includes that each of the one or more ML models corresponds to the BMG being indexed to one or more second ML models corresponding to the SMG.

Aspect 29 may be combined with any of aspects 1-28 and further includes reporting a UE capability indicative of executing the one or more ML models in association with the at least one of the BMG or the SMG.

Aspect 30 may be combined with any of aspects 1-29 and further includes switching between the one or more ML models based on the allocation of the one or more ML models and the at least one of the task or the condition of the at least one procedure.

Aspect 31 may be combined with any of aspects 1-30 and further includes performing the method based on at least one of an antenna or a transceiver.

Aspect 32 is a method of wireless communication at a base station including receiving an indication of a UE capability for executing one or more ML models allocated to at least one of a BMG or an SMG; and transmitting a configuration for the one or more ML models, the configuration associated with at least one of a task or a condition of at least one procedure, the configuration for switching between the one or more ML models based on the at least one of the task or the condition of the at least one procedure.

Aspect 33 may be combined with aspect 32 and includes that the one or more ML models allocated to the BMG correspond to first ML models of a first complexity and a first performance.

Aspect 34 may be combined with any of aspects 32-33 and includes that the one or more ML models allocated to the SMG correspond to second ML models of a second complexity and a second performance that are higher than the first complexity and the first performance.

Aspect 35 may be combined with any of aspects 32-34 and includes that the one or more ML models are allocated to the BMG based on an ML inference.

Aspect 36 may be combined with any of aspects 32-35 and includes that the one or more ML models are allocated to the SMG based on the UE capability.

Aspect 37 may be combined with any of aspects 32-36 and includes that the one or more ML models are sub-allocated within the at least one of the BMG or the SMG to at least one of a BMG subgroup or an SMG subgroup.

Aspect 38 may be combined with any of aspects 32-37 and includes that the BMG subgroup corresponds to at least one of a common function subgroup, a downlink/uplink subgroup, or an advanced function subgroup.

Aspect 39 may be combined with any of aspects 32-38 and includes that the SMG subgroup corresponds to at least one of a positioning subgroup, a CSF subgroup, or a decoding subgroup.

Aspect 40 may be combined with any of aspects 32-39 and includes that the one or more ML models are allocated to the at least one of the BMG or the SMG based on a performance associated with the one or more ML models.

Aspect 41 may be combined with any of aspects 32-40 and includes that the one or more ML models are allocated to the BMG based on a first performance associated with a plurality of tasks.

Aspect 42 may be combined with any of aspects 32-41 and includes that the one or more ML models are allocated to the SMG based on a second performance associated with a single task.

Aspect 43 may be combined with any of aspects 32-39 and includes that the one or more ML models are allocated to the at least one of the BMG or the SMG based on a complexity of the one or more ML models.

Aspect 44 may be combined with any of aspects 32-39 and 43 and includes that the one or more ML models are allocated to the BMG based on a first complexity.

Aspect 45 may be combined with any of aspects 32-39 and 43-44 and includes that the one or more ML models are allocated to the SMG based on a second complexity that is higher than the first complexity.

Aspect 46 may be combined with any of aspects 32-39 and includes that the one or more ML models are allocated to the at least one of the BMG or the SMG based on an initialization time.

Aspect 47 may be combined with any of aspects 32-39 and 46 and includes that the one or more ML models are allocated to the BMG at the initialization time.

Aspect 48 may be combined with any of aspects 32-39 and 46-47 and includes that the one or more ML models are allocated to the SMG after the initialization time.

Aspect 49 may be combined with any of aspects 32-39 and includes that the one or more ML models are allocated to the at least one of the BMG or the SMG based on an application of the one or more ML models.

Aspect 50 may be combined with any of aspects 32-39 and 49 and includes that the BMG corresponds to a cell-specific application.

Aspect 51 may be combined with any of aspects 32-39 and 49-50 and includes that the SMG corresponds to at least one of a UE-specific application or a UE group-specific application.

Aspect 52 may be combined with any of aspects 32-39 and includes that the one or more ML models are allocated to the at least one of the BMG or the SMG based on a priority level of the one or more ML models.

Aspect 53 may be combined with any of aspects 32-39 and 52 and includes that the BMG corresponds to a first ML model of a first priority level.

Aspect 54 may be combined with any of aspects 32-39 and 52-53 and includes that the SMG corresponds to a second ML model of a second priority level that is higher than the first priority level.

Aspect 55 may be combined with any of aspects 32-54 and further includes transmitting a second configuration for one or more second ML models.

Aspect 56 may be combined with any of aspects 32-55 and includes that the configuration for the one or more ML models corresponds to the BMG or the SMG.

Aspect 57 may be combined with any of aspects 32-56 and includes that the second configuration for the one or more second ML models corresponds to an opposite one of the BMG or the SMG from the configuration of the one or more ML models.

Aspect 58 may be combined with any of aspects 32-54 and includes that the configuration for the one or more ML models corresponds to the BMG.

Aspect 59 may be combined with any of aspects 32-54 and 58 and includes that each of the one or more ML models corresponds to the BMG being indexed to one or more second ML models corresponding to the SMG.

Aspect 60 may be combined with any of aspects 32-59 and further includes performing the method based on at least one of an antenna or a transceiver.

Aspect 61 is an apparatus for wireless communication at UE configured to perform the method of any of aspects 1-31.

Aspect 62 is an apparatus for wireless communication including means for performing the method of any of aspects 1-31.

Aspect 63 is a non-transitory computer-readable storage medium storing computer executable code, the code when executed by at least one processor causes the at least one processor to perform the method of any of aspects 1-31.

Aspect 64 is an apparatus for wireless communication at UE configured to perform the method of any of aspects 32-60.

Aspect 65 is an apparatus for wireless communication including means for performing the method of any of aspects 32-60.

Aspect 66 is a non-transitory computer-readable storage medium storing computer executable code, the code when executed by at least one processor causes the at least one processor to perform the method of any of aspects 32-60.

What is claimed is:

1. An apparatus for wireless communication at a user equipment (UE), comprising:
a memory; and
at least one processor coupled to the memory, the memory and the at least one processor configured to:
receive a configuration for one or more machine learning (ML) models, the configuration associated with at least one of a task or a condition of at least one procedure of the UE; and
allocate the one or more ML models to at least one of a baseline model group (BMG) or a specific model group (SMG) for switching between the one or more ML models based on the at least one of the task or the condition of the at least one procedure of the UE.

2. The apparatus of claim 1, wherein the one or more ML models allocated to the BMG correspond to first ML models of a first complexity and a first performance, and wherein the one or more ML models allocated to the SMG correspond to second ML models of a second complexity and a second performance that are higher than the first complexity and the first performance.

3. The apparatus of claim 1, wherein the one or more ML models are switchable at the UE based on the at least one of the task or the condition of the at least one procedure of the UE.

4. The apparatus of claim 1, wherein the one or more ML models are allocated to at least one of the BMG based on an ML inference or the SMG based on a UE capability.

5. The apparatus of claim 1, wherein the memory and the at least one processor are further configured to sub-allocate the one or more ML models allocated to the at least one of the BMG or the SMG into at least one of a BMG subgroup or an SMG subgroup, the BMG subgroup corresponding to at least one of a common function subgroup, a downlink/uplink subgroup, or an advanced function subgroup, the SMG subgroup corresponding to at least one of a positioning subgroup, a channel state feedback (CSF) subgroup, or a decoding subgroup.

6. The apparatus of claim 1, wherein the one or more ML models are allocated to the at least one of the BMG or the SMG based on a performance associated with the one or more ML models, the one or more ML models allocated to the BMG based on a first performance associated with a plurality of tasks, the one or more ML models allocated to the SMG based on a second performance associated with a single task.

7. The apparatus of claim 1, wherein the one or more ML models are allocated to the at least one of the BMG or the SMG based on a complexity of the one or more ML models, the one or more ML models allocated to the BMG based on a first complexity, the one or more ML models allocated to the SMG based on a second complexity that is higher than the first complexity.

8. The apparatus of claim 1, wherein the one or more ML models are allocated to the at least one of the BMG or the SMG based on an initialization time of the UE, the one or more ML models allocated to the BMG at the initialization time of the UE, the one or more ML models allocated to the SMG after the initialization time of the UE.

9. The apparatus of claim 1, wherein the one or more ML models are allocated to the at least one of the BMG or the SMG based on an application of the one or more ML models, the BMG corresponding to a cell-specific application, the SMG corresponding to at least one of a UE-specific application or a UE group-specific application.

10. The apparatus of claim 1, wherein the one or more ML models are allocated to the at least one of the BMG or the SMG based on a priority level of the one or more ML models, the BMG corresponding to a first ML model of a first priority level, the SMG corresponding to a second ML model of a second priority level that is higher than the first priority level.

11. The apparatus of claim 1, wherein the memory and the at least one processor are further configured to receive a second configuration for one or more second ML models, the configuration for the one or more ML models corresponding to the BMG or the SMG, the second configuration for the one or more second ML models corresponding to an opposite one of the BMG or the SMG from the configuration of the one or more ML models.

12. The apparatus of claim 1, wherein the configuration for the one or more ML models corresponds to the BMG, each of the one or more ML models corresponding to the BMG being indexed to one or more second ML models corresponding to the SMG.

13. The apparatus of claim 1, further comprising an antenna coupled to the at least one processor, wherein the memory and the at least one processor are further configured to report, via the antenna, a UE capability for execution of the one or more ML models in association with the at least one of the BMG or the SMG.

14. The apparatus of claim 1, wherein the memory and the at least one processor are further configured to switch between the one or more ML models based on the allocation of the one or more ML models and the at least one of the task or the condition of the at least one procedure of the UE.

15. An apparatus for wireless communication at a base station, comprising:
a memory; and
at least one processor coupled to the memory, the memory and the at least one processor configured to:
receive an indication of a user equipment (UE) capability for execution of one or more machine learning (ML) models allocated to at least one of a baseline model group (BMG) or a specific model group (SMG); and
transmit a configuration for the one or more ML models, the configuration associated with at least one of a task or a condition of at least one procedure, the configuration for switching between the one or more ML models based on the at least one of the task or the condition of the at least one procedure.

16. The apparatus of claim 15, wherein the one or more ML models allocated to the BMG correspond to first ML models of a first complexity and a first performance, and wherein the one or more ML models allocated to the SMG correspond to second ML models of a second complexity and a second performance that are higher than the first complexity and the first performance.

17. The apparatus of claim 15, wherein the one or more ML models are allocated to at least one of the BMG based on an ML inference or the SMG based on the UE capability.

18. The apparatus of claim 15, wherein the one or more ML models are sub-allocated within the at least one of the BMG or the SMG to at least one of a BMG subgroup or an SMG subgroup, the BMG subgroup corresponding to at least one of a common function subgroup, a downlink/uplink subgroup, or an advanced function subgroup, the SMG subgroup corresponding to at least one of a positioning subgroup, a channel state feedback (CSF) subgroup, or a decoding subgroup.

19. The apparatus of claim 15, wherein the one or more ML models are allocated to the at least one of the BMG or the SMG based on a performance associated with the one or more ML models, the one or more ML models allocated to the BMG based on a first performance associated with a plurality of tasks, the one or more ML models allocated to the SMG based on a second performance associated with a single task.

20. The apparatus of claim 15, wherein the one or more ML models are allocated to the at least one of the BMG or the SMG based on a complexity of the one or more ML models, the one or more ML models allocated to the BMG based on a first complexity, the one or more ML models allocated to the SMG based on a second complexity that is higher than the first complexity.

21. The apparatus of claim 15, wherein the one or more ML models are allocated to the at least one of the BMG or the SMG based on an initialization time, the one or more ML models allocated to the BMG at the initialization time, the one or more ML models allocated to the SMG after the initialization.

22. The apparatus of claim 15, wherein the one or more ML models are allocated to the at least one of the BMG or the SMG based on an application of the one or more ML models, the BMG corresponding to a cell-specific application, the SMG corresponding to at least one of a UE-specific application or a UE group-specific application.

23. The apparatus of claim 15, wherein the one or more ML models are allocated to the at least one of the BMG or the SMG based on a priority level of the one or more ML models, the BMG corresponding to a first ML model of a first priority level, the SMG corresponding to a second ML model of a second priority level that is higher than the first priority level.

24. The apparatus of claim 15, further comprising an antenna coupled to the at least one processor, wherein the memory and the at least one processor are further configured to transmit, via the antenna, a second configuration for one or more second ML models, the configuration for the one or more ML models corresponding to the BMG or the SMG, the second configuration for the one or more second ML models corresponding to an opposite one of the BMG or the SMG from the configuration of the one or more ML models.

25. The apparatus of claim 15, wherein the configuration for the one or more ML models corresponds to the BMG, each of the one or more ML models corresponding to the BMG being indexed to one or more second ML models corresponding to the SMG.

26. A method of wireless communication at a user equipment (UE), comprising:
receiving a configuration for one or more machine learning (ML) models, the configuration associated with at least one of a task or a condition of at least one procedure of the UE; and
allocating the one or more ML models to at least one of a baseline model group (BMG) or a specific model group (SMG) for switching between the one or more ML models based on the at least one of the task or the condition of the at least one procedure of the UE.

27. The method of claim 26, wherein the one or more ML models allocated to the BMG correspond to first ML models of a first complexity and a first performance, and wherein the one or more ML models allocated to the SMG correspond to second ML models of a second complexity and a second performance that are higher than the first complexity and the first performance.

28. The method of claim 26, wherein the one or more ML models are switchable at the UE based on the at least one of the task or the condition of the at least one procedure of the UE.

29. A method of wireless communication at a base station, comprising:
receiving an indication of a user equipment (UE) capability for executing one or more machine learning (ML) models allocated to at least one of a baseline model group (BMG) or a specific model group (SMG); and
transmitting a configuration for the one or more ML models, the configuration associated with at least one of a task or a condition of at least one procedure, the configuration for switching between the one or more ML models based on the at least one of the task or the condition of the at least one procedure.

30. The method of claim 29, wherein the one or more ML models allocated to the BMG correspond to first ML models of a first complexity and a first performance, and wherein the one or more ML models allocated to the SMG correspond to second ML models of a second complexity and a second performance that are higher than the first complexity and the first performance.
